(19) United States
(12) Patent Application Publication
(10) Pub. No.: US 2010/0200144 A1
(43) Pub. Date: Aug. 12, 2010

(54) BONDING METHOD, BONDED BODY, DROPLET EJECTION HEAD, AND DROPLET EJECTION APPARATUS

(75) Inventor: Yasuhide Matsuo, Nagano (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/665,259

(22) PCT Filed: Jun. 16, 2008
(86) PCT No.: PCT/JP2008/060987

§ 371 Date: Dec. 17, 2009

(30) Foreign Application Priority Data
Jun. 18, 2007 (JP) 2007-160797
Jun. 2, 2008 (JP) 2008-145158

(51) Int. Cl. B32B 37/12; B32B 9/00; B41J 2/015

(52) U.S. Cl. 156/60; 156/329; 156/273.3; 428/411.1; 347/20

(57) ABSTRACT

A bonding method of manufacturing a bonded body is provided. The bonding method comprises: after providing a first object in which a plasma polymerization film having a surface is formed on a base member, applying an energy to the surface of the plasma polymerization film to activate the surface; after providing a second object having a surface to be bonded to the surface of the plasma polymerization film of the first object and no plasma polymerization film onto the surface of the second object, bonding the surface of the second object and the surface of the activated plasma polymerization film so that the surface of the plasma polymerization film is bonded to the surface of the second object to obtain the bonded body.

### CROSS-REFERENCE TO RELATED APPLICATION

This application claims priorities to Japanese Patent Application No. 2007-160797 filed on Jun. 18, 2007 and Japanese Patent Application No. 2008-145158 filed on Jun. 2, 2008 which are hereby expressly incorporated by reference herein in their entireties.

### BACKGROUND

1. Technical Field

The present invention relates to a bonding method, a bonded body, a droplet ejection head, and a droplet ejection apparatus, and more specifically relates to a bonding method, a bonded body manufactured by the bonding method, a droplet ejection head including the bonded body, and a droplet ejection apparatus provided with the droplet ejection head.

2. Related Art

Conventionally, in the case where two members (base members) are bonded together, an adhesive such as an epoxy-based adhesive, an urethane-based adhesive, or a silicone-based adhesive has been often used.

In general, an adhesive exhibits reliably high adhesiveness regardless of constituent materials of the members to be bonded. Therefore, members formed of various materials can be bonded together in various combinations.

For example, a droplet ejection head (an ink-jet type recording head) included in an ink-jet printer is assembled by bonding, using an adhesive, several members formed of different kinds of materials such as a resin-based material, a metal-based material, and a silicon-based material.

When the members are to be bonded together using the adhesive to obtain an assembled body composed from the members, a liquid or paste adhesive is applied to surfaces of the members, and then the members are attached to each other via the applied adhesive on the surfaces thereof and firmly fixed together by hardening (setting) the adhesive with an action of heat or light. By doing so, the members are bonded together due to a physical interaction such as an anchor effect and a chemical interaction such as a chemical bond.

However, when the adhesive is applied to the surfaces of the members to be bonded together, a complicated method such as a printing method has to be used. Further, a thickness of the applied adhesive is affected by a lot of parameters such as a viscosity of the adhesive, an atmosphere temperature, humidity, conditions of a printing device, and the like. Therefore, it is very hard that the thickness of the applied adhesive is determined in a rigorous manner.

For this reason, there is a problem in that it is impossible to improve dimensional accuracy of a bonded body. As a result, in a case where a structural object requiring high dimensional accuracy is manufactured by using the adhesive as the droplet ejection head described above, there is a fear that the following problems are caused by the use of the adhesive. The problems are that the use of the adhesive makes the dimensional accuracy of the droplet ejection head low, thereby having an adverse affect on printing performance of a printer.

Further, since a very long period of time is needed to harden such an adhesive, there is also a problem in that a long period of time is needed to bond the members together. Furthermore, it is often necessary to treat the surfaces of the members to be bonded using a primer in order to improve the bonding strength between the members. Therefore, additional cost and labor hour are required for performing the primer treatment, which causes an increase in cost and complexity of the process for bonding the members.

On the other hand, as a method of bonding members without using the adhesive, there is known a solid bonding method. The solid bonding method is a method of directly bonding members without an intervention of an intermediate layer composed of an adhesive or the like (see, for example, the following Patent Document).

Since such a solid bonding method does not need to use any intermediate layer composed of the adhesive or the like for bonding the members, it is possible to obtain a bonded body of the members having high dimensional accuracy.

However, in the solid bonding method, there is a problem in that constituent materials of the members are limited to specific materials. To be concrete, generally, in the solid bonding method, members to be bonded together have to be made of the same material. Further, the constituent materials to be capable of bonding together are limited to a silicon-based material, specific metal-based materials, and the like.

Furthermore, there is also another problem in a bonding process. Such a problem includes that an atmosphere in which the solid bonding method is performed is limited to a reduced-pressure atmosphere, a heating process is carried out at a high temperature (about 700 to 800° C.), and the like.

In view of such problems, there is a demand for a solid bonding method which is capable of firmly and efficiently bonding two members with high dimensional accuracy.

The patent document is JP A-5-82404 as an example of related art.

### SUMMARY

Accordingly, it is an object of the present invention to provide a bonding method being capable of firmly and efficiently bonding two members together with high dimensional accuracy, and a bonded body manufactured by firmly bonding two members together with high dimensional accuracy.

Further, it is another object of the present invention to provide a droplet ejection head including the bonded body and having high reliability, and a droplet ejection apparatus provided with such a droplet ejection head.

These objects are achieved by the present invention described below.

In a first aspect of the present invention, there is provided a bonding method. The bonding method comprises: after providing a first object in which a plasma polymerization film having a surface is formed on a base member, applying an energy to the surface of the plasma polymerization film to activate the surface; and after providing a second object having a surface to be bonded to the surface of the plasma polymerization film of the first object and no plasma polymerization film onto the surface of the second object, bonding the surface of the second object and the surface of the activated plasma polymerization film so that the surface of the plasma polymerization film is bonded to the surface of the second object to obtain the bonded body.

According to such a bonding method of the present invention, it is possible to efficiently and firmly bond the two base members together with high dimensional accuracy.

In the above bonding method, it is preferred that the second object includes bonds, hydroxyl groups bonded to the bonds and active bonding hands formed by cutting the bonds, wherein at least one of the hydroxyl groups and the active bonding hands exists on the surface of the second object. The surface of the second object is bonded to the surface of the plasma polymerization film.

According to the bonding method described above, it is possible to increase bonding strength between the surface of the second object and the surface of the plasma polymerization film, so that it is to possible more firmly bond the two objects (that is, the first object and the second object) together through the plasma polymerization film.

In the above bonding method, it is also preferred that the surface of the second object is covered with an oxide film.

According to the bonding method described above, even if the surface of the second object is not subjected to a treatment of bonding hydroxyl groups thereto, it is possible to more firmly bond the two objects together through the plasma polymerization film.

In the above bonding method, it is also preferred that the plasma polymerization film is constituted of polyorganosiloxane or an organic metallic polymer as a main component thereof.

According to the bonding method described above, it is possible to more firmly bond the first object and the second object together through the plasma polymerization film.

In the above bonding method, it is also preferred that the polyorganosiloxane is constituted of a polymer of octamethyltrisiloxane as a main component thereof.

According to the bonding method described above, it is possible to obtain a plasma polymerization film that can exhibit superior bonding property.

In the above bonding method, it is also preferred that the polyorganosiloxane includes Si—H bonds in a chemical structure thereof.

The inventors think that the Si—H bonds are served to prevent siloxane bonds from being regularly formed. Therefore, the siloxane bonds are formed so as to avoid the Si—H bonds, so that the regularity of a Si-skeleton included in polyorganosiloxane is lowered. As a result, crystallinity of the plasma polymerization film constituted of polyorganosiloxane as a main component thereof is lowered, thereby increasing the bonding strength, chemical resistance, and dimensional accuracy thereof.

In the above bonding method, it is also preferred that the plasma polymerization film constituted of the polyorganosiloxane including the Si—H bonds and siloxane bonds is subjected to an infrared adsorption spectroscopy to obtain spectrum having peaks, wherein when an intensity of the peak derived from the siloxane bonds is defined as “1”, an intensity of the peak derived from the Si—H bonds is in the range of 0.001 to 0.2.

According to the bonding method described above, a skeleton part in the plasma polymerization film is constructed from the siloxane bonds, thereby providing both actions of increasing film strength of the plasma polymerization film and lowering the crystallinity of polyorganosiloxane by the Si-bonds. As a result, it is possible for the plasma polymerization film to exhibit superior bonding strength, chemical resistance, and dimensional accuracy thereof.

In the above bonding method, it is also preferred that the plasma polymerization film constituted of the polyorganosiloxane including siloxane bonds and methyl groups is subjected to an infrared adsorption spectroscopy to obtain spectrum having peaks, wherein when an intensity of the peak derived from the siloxane bonds is defined as “1”, an intensity of the peak derived from the methyl groups is in the range of 0.05 to 0.45.

According to the bonding method described above, it is possible to impart sufficiently bonding property to the plasma polymerization film. This is because a necessary and sufficient number of active hands are generated in polyorganosiloxane while preventing the methyl groups from interfering the production of the siloxane bonds more than necessary. In addition to that, sufficient weather resistance and chemical resistance arising from the methyl groups are generated to the plasma polymerization film.

In the above bonding method, it is also preferred that the organic metallic polymer is constituted of a polymer of trimethylgallium or trimethylaluminum as a main component thereof.

According to the bonding method described above, it is possible to impart conductive property to the plasma polymerization film and firmly bond the first object and the second object together through the plasma polymerization film.

In the above bonding method, it is also preferred that an average thickness of the plasma polymerization film is in the range of 10 to 10000 nm.

According to the bonding method described above, it is possible to more firmly bond the first object and the second object together through the plasma polymerization film while preventing dimensional accuracy of the bonded body formed by bonding them from conspicuously being lowered.

In the above bonding method, it is also preferred that the energy includes an energy beam, wherein the energy beam is irradiated to the surface of the plasma polymerization film in the applying the energy to the surface of the plasma polymerization film.

According to the bonding method described above, it is possible to efficiently activate the surface of the plasma polymerization film. Further, since a chemical structure of the plasma polymerization film is not destroyed more than necessary, it is possible to prevent performances of the plasma polymerization film from being lowered.

In the above bonding method, it is also preferred that the energy beam is an ultraviolet light having a wavelength of 150 to 300 nm.

According to the bonding method described above, it is possible to uniformly activate a large region of the surface of the plasma polymerization film for a short period of time while preventing performances of the plasma polymerization film from being severely lowered. This makes it possible to efficiently activate the surface of the plasma polymerization film.

In the above bonding method, it is also preferred that the applying the energy to the surface of the plasma polymerization film is performed in an atmosphere.

According to the bonding method described above, it is possible to easily perform a process to activate the surface of the plasma polymerization film without labor hour and additional costs to control the atmosphere.

In the above bonding method, it is also preferred that the bonding method further comprises subjecting the bonded body to a heating treatment after bonding the surface of the second object and the surface of the activated plasma polymerization film.

According to the bonding method described above, it is possible to increase bonding strength between the surface of the plasma polymerization film and the surface of the second object in the bonded body.

In the above bonding method, it is also preferred that the heating treatment is performed at a temperature in the range of 25 to 100° C.

According to the bonding method described above, it is possible to reliably increase bonding strength of the bonded body while reliably preventing the bonded body from being altered or deteriorated by heat.

In the above bonding method, it is also preferred that the bonding method further comprises pressuring the bonded body after bonding the surface of the second object and the surface of the activated plasma polymerization film.

According to the bonding method described above, it is possible to increase bonding strength between the surface of the plasma polymerization film and the surface of the second object in the bonded body.

In the above bonding method, it is also preferred that the pressuring the bonded body is performed under a pressure in the range of 1 to 10 MPa.

According to the bonding method described above, it is possible to reliably increase bonding strength of the bonded body without damages which are likely to occur to the base member.

In the above bonding method, it is also preferred that the bonding the surface of the second object and the surface of the activated plasma polymerization film is started within 60 minutes after the applying the energy to the surface of the plasma polymerization film.

According to the bonding method described above, it is possible to maintain the surface of the plasma polymerization film in a sufficient active state. Therefore, when the first object and the second object are bonded to each other, it is possible to obtain sufficient bonding strength.

In the above bonding method, it is also preferred that the base member has a surface on which the plasma polymerization film is formed, wherein the providing the first object includes subjecting the surface of the base member to a surface treatment using plasma, and then forming the plasma polymerization film on the surface-treated surface of the base member to obtain the first object.

According to the bonding method described above, when the surface (bonding surface) of the base member is cleaned and activated, and then the plasma polymerization film is formed on the bonding surface, it is possible to increase bonding strength between the bonding surface and the surface of the plasma polymerization film.

In a second aspect of the present invention, there is provided a bonded body. The bonded body comprises: a first base member; a plasma polymerization film formed on the first base member, the plasma polymerization film having a surface; and a second base member formed on the surface of the plasma polymerization film. The second base member is bonded to the first base member through the plasma polymerization film.

According to the bonded body described above, it is possible to obtain a bonded body manufactured by firmly bonding two base members (the first base member and the second base member) together with high dimensional accuracy.

In a third aspect of the present invention, there is provided a droplet ejection head provided with the bonded body described above.

According to the droplet ejection head described above, it is possible to provide a droplet ejection head having high reliability.

In a fourth aspect of the present invention, there is provided a droplet ejection apparatus provided with the droplet ejection head described above.

According to the droplet ejection apparatus described above, it is possible to provide a droplet ejection apparatus having high reliability.

### BRIEF DESCRIPTION OF THE DRAWINGS

FIG. 1 is a vertical section view schematically showing a plasma polymerization apparatus used for a bonding method according to the present invention.

FIGS. 2A to 2D are vertical sectional views for explaining a first embodiment of a bonding method according to the present invention.

FIGS. 3E to 3G are vertical sectional views for explaining a first embodiment of a bonding method according to the present invention.

FIG. 4 is an exploded perspective view showing a droplet ejection head produced by using the bonded body according to the present invention, wherein the droplet ejection head is configured as an ink jet type recording head.

FIG. 5 is a section view of the ink jet type recording head shown in FIG. 4.

FIG. 6 is a schematic view showing one embodiment of an ink jet printer provided with the ink jet type recording head shown in FIG. 4.

### DESCRIPTION OF EXEMPLARY EMBODIMENTS

Hereinbelow, a bonding method, a bonded body, a droplet ejection head, and a droplet ejection apparatus according to the present invention will be described in detail with reference to preferred embodiments shown in the accompanying drawings.

Bonding Method

A bonding method according to the present invention is a method of bonding two base members (a first base member 21 and a second base member 22) together through a plasma polymerization film 3. According to such a bonding method, it is possible to efficiently and firmly bond the first base member 21 and the second base member 22 together with high dimensional accuracy.

Hereinafter, a description will be made on the bonding method according to the present invention. First, prior to the description of the bonding method according to the present invention, a description will be made on a plasma polymerization apparatus used for producing the plasma polymerization film 3 formed on the first base member 21.

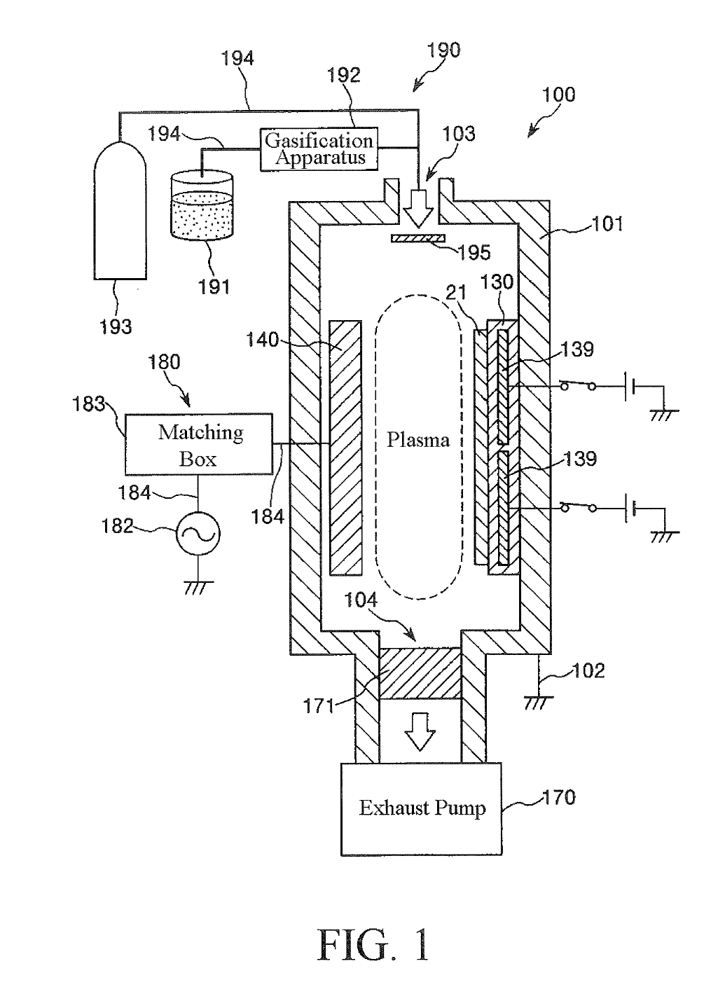

FIG. 1 is a vertical section view schematically showing a plasma polymerization apparatus used for a bonding method according to the present invention. In the following description, the upper side in FIG. 1 will be referred to as “upper” and the lower side thereof will be referred to as “lower” for convenience of explanation.

The plasma polymerization apparatus shown in FIG. 1 includes a chamber 101, a first electrode 130 formed on an inner surface of the chamber 101, a second electrode 140 facing the first electrode 130, a power circuit 180 for applying a high-frequency voltage across the first electrode 130 and the second electrode 140, a gas supply part 190 for supplying a gas into the chamber 101, and a exhaust pump 170 for exhausting the gas supplied into the chamber 101 by the gas supply part 190.

Among these parts, the first electrode 130 and the second electrode 140 are provided in the chamber 101. Hereinafter, a description will be made on these parts in detail.

The chamber 101 is a vessel that can maintain air-tight condition of the inside thereof. Since the chamber 101 is used in a state of a reduced pressure (vacuum) of the inside thereof, the chamber 101 has pressure resistance property which is property that can withstand a pressure difference between the inside and the outside of the chamber 101.

The chamber 101 shown in FIG. 1 is composed from a chamber body of a substantially cylindrical shape, of which axial line is provided along a vertical direction. A supply opening 103 is provided in an upper side of the chamber 101. An exhaust opening 104 is provided in a lower side of the chamber 101. A gas pipe 194 of the gas supply part 190 is connected to the supply opening 103. The exhaust pump 170 is connected to the exhaust opening 104.

In the present embodiment, the chamber 101 is constituted of a metal material having high conductive property and is electrically grounded through a grounding conductor 102.

The first electrode 130 has a plate shape and supports the first base member 21. In other words, the first base member 21 is provided on the surface of the first electrode 130. The first electrode 130 is provided on the inner surface of the chamber 101 along a vertical direction. In this way, the first electrode 130 is electrically grounded through the chamber 101 and the grounding conductor 102. In this regard, it is to be noted that the first electrode 130 is formed in a concentric manner as the chamber body as shown in FIG. 1.

An electrostatic chuck (attraction mechanism) 139 is provided in the first electrode 130. As shown in FIG. 1, the first base member 21 can be attracted by the electrostatic chuck 139 along the vertical direction. With this structure, even if some warpage have been formed to the first base member 21, the first base member 21 can be subjected to a plasma treatment in a state that the warpage is corrected by attracting first base member 21 to the electrostatic chuck 139.

The second electrode 140 is provided in facing the first electrode 130 through the first base member 21. In this regard, it is to be noted that the second electrode 140 is provided in a spaced-apart relationship (a state of insulating) with the inner surface of the chamber 101.

A high-frequency power 182 is connected to the second electrode 140 through a wire 184 and a matching box 183. The matching box 183 is provided on the way of wire 184 which is provided between the second electrode 140 and the high-frequency power 182. The power circuit 180 is composed from the wire 184, the high-frequency power 182 and the matching box 183.

According to the power circuit 180, a high-frequency voltage is applied across the first electrode 130 and the second electrode 140 due to ground of the first electrode 130. Therefore, an electric field in which a movement direction of an electronic charge carrier is alternated in high frequency is formed between the first electrode 130 and the second electrode 140.

The gas supply part 190 supplies a predetermined gas into the chamber 101. The gas supply part 190 shown in FIG. 1 has a liquid reservoir part 191 for reserving a film material in a liquid form (raw liquid), a gasification apparatus 192 for changing the film material in the liquid form to the film material in a gas form, and a gas cylinder 193 for reserving a carrier gas.

The liquid reservoir part 191, the gasification apparatus 192, the gas cylinder 193 and the supply part 103 of the chamber 101 are connected with a wire 194. A mixture gas of the film material in the gas form and the carrier gas are supplied from the supply part 103 into the chamber 101.

The film material in the liquid form reserved in the liquid reservoir part 191 is a raw material that is polymerized by using the plasma polymerization apparatus 100 so that a plasma polymerization film is formed on the surface of the first base member 21. Such a film material in the liquid form is gasified by the gasification apparatus 192, thereby changing to the film material in the gas form (raw gas). Then, the film material in the gas form is supplied into the chamber 101. In this regard, the raw gas will be described later in detail.

The carrier gas reserved in the gas cylinder 193 is discharged in the electric field and supplied in the chamber 101 in order to maintain the discharge. Examples of such a carrier gas include Ar gas, He gas and the like. A diffuser plate 195 is provided near the supply part 103 of the inside of the chamber 101.

The diffuser plate 195 has a function of accelerating diffusion of the mixture gas supplied into the chamber 101. This makes it possible to uniformly diffuse the mixture gas in the chamber 101.

The exhaust pump 170 exhausts the mixture gas in the chamber 101 and is composed from a oil-sealed rotary pump, a turbo-molecular pump or the like. By exhausting an air and reducing pressure in the chamber 101, it is possible to easily change the mixture gas to plasma.

Further, it is also possible to prevent the first base member 21 from being contaminated or oxidized by contacting with the atmosphere. Furthermore, it is also possible to efficiently remove reaction products obtained by subjecting the first base member 21 to plasma polymerization apparatus 100 from the inside of the chamber 101.

A pressure control mechanism 171 for adjusting the pressure in the chamber 101 is provided in the exhaust opening 104. This makes it possible to appropriately set the pressure in the chamber 101 depending on a supply amount of the mixture gas.

Next, a description will be made on a case using the plasma polymerization apparatus 100 described above about an embodiment of the bonding method according to the present invention.

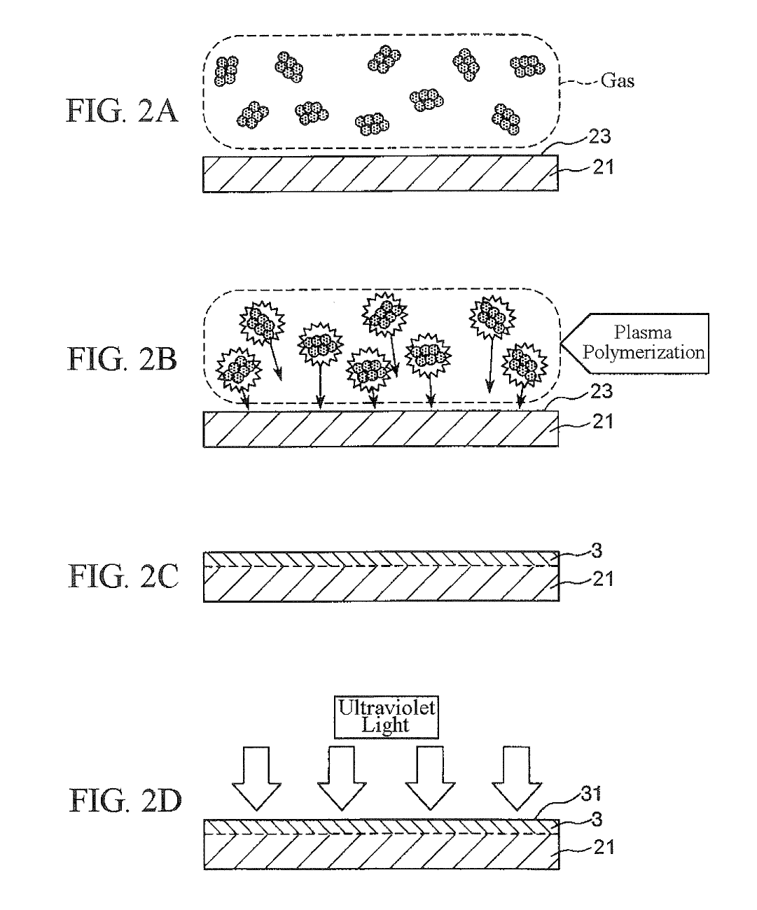

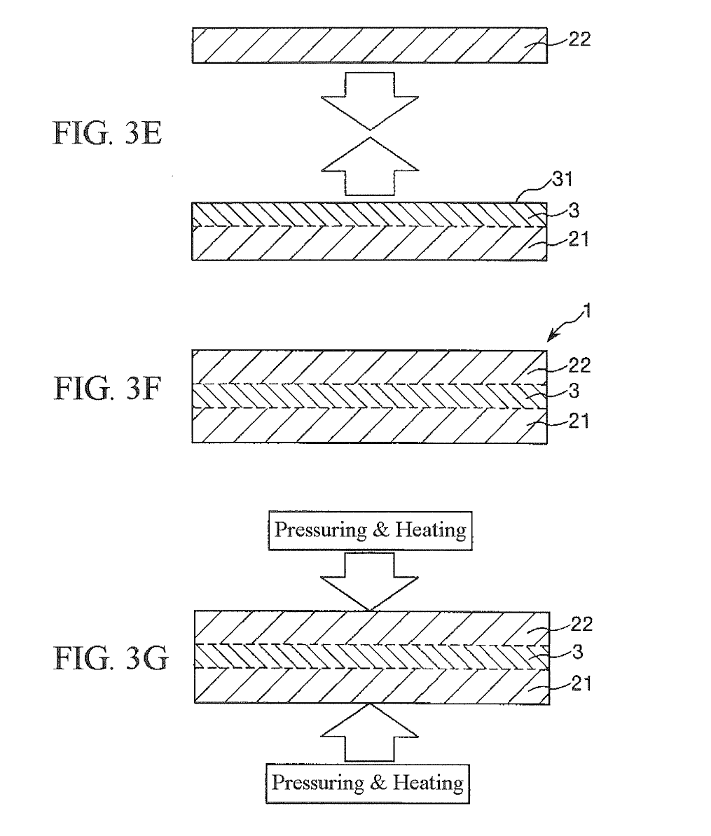

FIGS. 2A to 2D and 3E to 3G are vertical sectional views for explaining a first embodiment of a bonding method according to the present invention. In the following description, the upper side in each of FIGS. 2A to 2D and 3E to 3G will be referred to as “upper” and the lower side thereof will be referred to as “lower” for convenience of explanation.

The bonding method according to this embodiment includes a first step, a second step, a third step, and a fourth step as described below.

The first step is a step of providing the first base member 21, and then forming the plasma polymerization film 3 on the surface 23 of the first base member 21.

The second step is a step of applying energy to the surface 31 of the plasma polymerization film 3 to activate the surface 31 of the plasma polymerization film 3.

The third step is a step of providing a second base member 22 (second object) having no plasma polymerization film on the surface thereof to be bonded to the plasma polymerization film 3, and bonding the second base member 22 and the surface 31 of the plasma polymerization film 3 (first object) so that the second base member 22 is in contact with the surface 31 of the activated plasma polymerization film 3 to obtain a bonded body 1.

The fourth step is a step of heating and pressuring the bonded body 1.

In the bonding method according to the present invention, the first object used for the bonding method has the first base member 21 and the plasma polymerization film 3 formed on the surface 23 of the first base member 21. The second object used for the bonding method has the second base member 22.

In other words, the plasma polymerization film 3 is preliminarily formed on a bonding surface 23 of the first base member 21. However, a plasma polymerization film is not preliminarily formed on a bonding surface of the second base member 22.

Hereinafter, a description will be made on each step of the bonding method according to the present invention one after another.

Hereinafter, a description will be made on each step one after another.

[1] First, the first base member 21 is provided.

A constituent material of such a first base member 21 is not particularly limited to a specific material. Examples of the constituent material of the first base member 21 include: a resin material such as polyphenylene sulfide, an aramid-based resin, polyethylene terephthalate, polyethylene naphthalate, polypropylene, a cycloolefine polymer, polyamide, polyether sulfone, polymethyl(meth)acrylate, polycarbonate, and polyarylate; a metal material such as stainless steel, titanium, aluminum, tantalum, and indium tin oxide (ITO); a silicone material such as single crystal silicone, polycrystal silicone and a quartz glass; a ceramic material such as alumina; a complex material containing any one kind of the above materials or two or more kinds of the above materials; and the like.

Next, if needed, the surface (bonding surface) 23 of the first base member 21 is subjected to a surface treatment to clean and activate the bonding surface 23.

As a result, when the plasma polymerization film 3 is formed on the bonding surface 23 in the step described later, it is possible to increase bonding strength between the bonding surface 23 and the surface 31 of the plasma polymerization film 3.

Examples of such a surface treatment, but not limited thereto, include a plasma treatment performed using oxygen plasma, an etching treatment, an electron beam irradiation treatment, an ultraviolet ray irradiation treatment and the like.

In this regard, it is to be noted that in the case where the bonding surface 23 of the first base member 21 to be subjected to the surface treatment is formed of a resin material (a polymeric material), a corona discharge treatment, a nitrogen plasma treatment and the like are particularly preferably used.

[2] Next, as shown in FIGS. 2A to 2C, the plasma polymerization film 3 is formed on the bonding surface 23 of the first base member 21, which is referred to as the first step.

A mixture gas of a raw gas and a carrier gas is supplied into a strong electrical field to thereby polymerize molecules contained in the raw gas, so that such a plasma polymerization film 3 is obtained.

A description will be made on the concrete method. First, the first base member 21 is placed into the chamber 101 of the plasma polymerization apparatus 100. After the chamber is sealed, a pressure inside the chamber 101 is reduced by activating the exhaust pump 170.

Next, the mixture gas of the raw gas and the carrier gas is supplied into the chamber 101 by activating the gas supply part 190, thereby the chamber 101 is filled with the supplied mixture gas (FIG. 2A).

A ratio (mix ratio) of the raw gas in the mixture gas is preferably set in the range of about 20 to 70% and more preferably in the range of about 30 to 60%, though the ratio is slightly different depending on a kind of raw gas or carrier gas and an intended deposition speed. This makes it possible to optimize conditions for forming (depositing) the polymerization film (that is, the plasma polymerization film 3).

A flow rate of the supplying mixture gas, namely each of the raw gas and the carrier gas, is appropriately decided depending on a kind of raw gas or carrier gas, an intended deposition speed, a thickness of a film to be formed or the like. The flow rate is not particularly limited to a specific rate, but normally is preferably set in the range of about 1 to 100 ccm and more preferably in the range of about 10 to 60 ccm.

Next, a high-frequency voltage is applied across the first electrode 130 and the second electrode 140 by activating the power circuit 180. In this way, the molecules contained in the raw gas which exists between the first electrode 130 and the second electrode 140 are allowed to ionize, thereby generating plasma.

Then, the molecules contained in the raw gas are polymerized by plasma energy to obtain polymers, thereafter the obtained polymers are bonded to the bonding surface 23 of the first base member 21 and are deposited thereon as shown in FIG. 2B. As a result, as shown in FIG. 2C, the plasma polymerization film 3 is formed on the bonding surface 23 of the first base member 21.

Examples of the raw gas to be contained in the mixture gas include: organosiloxane such as methyl siloxane, octamethyl trisiloxane, decamethyl tetrasilixane, decamethyl cyclopentasiloxane, octamethyl cyclotetrasiloxane, and methylphenylsiloxane; an organic metallic-based compound such as trimethyl gallium, triethyl gallium, trimethyl aluminum, triethyl aluminum, tri-isobutyl aluminum, trimethyl indium, triethyl indium, trimethyl zinc, and triethyl indium; various kinds of hydrocarbon compounds; various kinds of fluorine-based compounds; and the like.

The plasma polymerization film 3 obtained by using such a raw gas (polymers) is obtained by polymerizing the raw materials thereof. That is to say, the plasma polymerization film 3 is constituted of polyorganosiloxane, an organic metallic polymer, a hydrocarbon-based polymer, fluorine-based polymer; and the like.

Among these polymers, it is preferred that the plasma polymerization film 3 is constituted of polyorganosiloxane, or the organic metallic polymer as a main component thereof. This makes it possible for the plasma polymerization film 3 to more firmly bond the first base member 21 and the second base member 22 together.

Polyorganosiloxane normally has repellency (non-bonding property). However, elimination groups such as organic groups contained in polyorganosiloxane can be easily eliminated by subjecting to various kinds of active treatment, so that polyorganosiloxane has hydrophilic property. That is, use of polyorganosiloxane makes it possible to easily control the hydrophilic property and the repellency of the plasma polymerization film 3.

In the steps described later, the plasma polymerization film 3 constituted of polyorganosiloxane having the repellency is in contact with the second base member 22. Even if so, the bonding of the plasma polymerization film 3 and the second base member 22 is prevented by the elimination groups such as the organic groups which exist on the surface of the plasma polymerization film 3. Therefore, the bonding is very difficult.

On the other hand, the plasma polymerization film 3 constituted of polyorganosiloxane having the hydrophilic property is in contact with the second base member 22. By doing so, the bonding of the plasma polymerization film 3 and the second base member 22 is capable.

An advantageous that it is possible to easily control the hydrophilic property and the repellency leads an advantageous that it is possible to easily control the bonding property. Therefore, the plasma polymerization film 3 constituted of polyorganosiloxane is preferably used for the bonding method according to the present invention.

Polyorganosiloxane has relatively high flexibility. Therefore, even if the constituent materials of the first base member 21 and the second base member 22 are different from each other, it is possible to reduce stress involving thermal expansion which may be occur to between the first base member 21 and the second base member 22. This makes it possible to reliably prevent peeling between the plasma polymerization film 3 and the second base member 22 in the bonded body 1 finally obtained.

Furthermore, polyorganosiloxane has superior chemical property. Therefore, polyorganosiloxane can be effectively used for bonding of members which are exposed to chemicals for a long period of time. For example, when a droplet ejection head included in an industrial ink jet printer, in which organic inks which degrade the resin material with ease are used, is manufactured, the use of the plasma polymerization film 3 mainly constituted of polyorganosiloxane makes it possible to improve the durability thereof.

Among polyorganosiloxane, the constituent material of the plasma polymerization film 3 is preferably constituted of a polymer of octamethyltrisiloxane as a main component thereof. The plasma polymerization film 3 constituted of the polymer of octamethyltrisiloxane as the main component thereof exhibits particularly superior bonding property. Therefore, such a plasma polymerization film 3 is preferably used for the bonding method according to the present invention.

Further, octamethyltrisiloxane is a liquid form at a normal temperature and has appropriate viscosity. Therefore, octamethyltrisiloxane has an advantage in that it can be easily handled.

It is preferred that polyorganosiloxane contains Si—H bonds in a chemical structure thereof. In polyorganosiloxane including the Si—H bonds appropriately, it is considered that the Si—H bonds prevent siloxane bonds from being regularly formed.

Therefore, the siloxane bonds are formed so as to avoid the Si—H bonds, which lower the regularity of Si-skeletons included in polyorganosiloxane. It is possible to obtain the plasma polymerization film 3 mainly constituted of polyorganosiloxane and having a low crystallinity degree.

Defects such as dislocation and shear, which are likely to occur in a specific crystal grain boundary of a crystal material, hardly occur to such a plasma polymerization film 3 having the low crystallinity degree. Therefore, the bonding strength, the chemical resistance, and the dimensional accuracy of the plasma polymerization film 3 are improved in itself. In addition to that, the bonding strength, the chemical resistance, and the dimensional accuracy of the bonded body 1 finally obtained are also improved.

On the other hand, the larger an amount of the Si—H bonds included in polyorganosiloxane is, the better the performance of the plasma polymerization film 3 is not improved. It is preferred that the amount of the Si—H bonds included in polyorganosiloxane falls within a predetermined range. The plasma polymerization film 3 constituted of Polyorganosiloxane is subjected to an infrared absorption measurement by using an infrared absorption measurement apparatus to obtain an infrared absorption spectrum having peaks.

Then, when an intensity of a peak derived from the siloxane bonds in the infrared absorption spectrum is defined as “1”, an intensity of a peak derived from Si—H bonds in the infrared absorption spectrum is preferably in the range of about 0.001 to 0.2, more preferably in the range of about 0.002 to 0.05 and even more preferably in the range of about 0.005 to 0.02.

By setting the intensity of the peak derived from the Si—H bonds with respect to the intensity of the peak derived from the siloxane bonds to a value within the above range, a skeleton part of the plasma polymerization film 3 is constructed by the siloxane bonds.

This makes it possible to provide both actions of increasing film strength of the plasma polymerization film 3 and lowering the crystallinity of polyorganosiloxane by the Si—H bonds. As a result, it is possible for the plasma polymerization film 3 to exhibit superior bonding strength, chemical resistance, and dimensional accuracy thereof.

The elimination groups described above are eliminated from the plasma polymerization film 3 by subjecting polyorganosiloxane (surface of the plasma polymerization film 3) to the active treatment. That is, the elimination groups are eliminated from the silicon atoms contained in the Si-skeleton of the plasma polymerization film 3 so that active hands are generated at portions of the Si-skeleton where the elimination groups have been existed.

In this way, the elimination groups are relatively easily and uniformly eliminated from the silicon atoms by applying energy. On the other hand, the elimination groups are reliably bonded to the silicon atoms contained in the Si-skeleton so as not to be eliminated therefrom when no energy is applied.

From this viewpoint, the elimination groups are preferably constituted of at least one selected from a group consisting of a hydrogen atom, a boron atom, a carbon atom, a nitrogen atom, an oxygen atom, a phosphorus atom, a sulfur atom, a halogen-based atom and an atom group in which these atoms are bonded to the constituent atoms of the Si-skeleton included in polyorganosiloxane.

Such elimination groups have relatively superior selectivity in bonding and eliminating to and from the silicon atoms by applying energy. Therefore, the elimination groups satisfy the needs as described above so that the first base member 21 with the plasma polymerization film 3 has high bonding property.

Examples of the atom group in which the atoms described above are bonded to the constituent atoms of the Si-skeleton included in polyorganosiloxane include: an alkyl group such as a methyl group and an ethyl group; an alkenyl group such as a vinyl group and an allyl group; an aldehyde group; a ketone group; a carboxyl group; an amino group; an amide group; a nitro group; a halogenated alkyl group; a mercapt group; a sulfone group; a cyano group; an isocyanate group; and the like.

Among these groups mentioned above, the elimination groups (organic groups) are preferably the alkyl group. Since an alkyl group has chemically high stability, the plasma polymerization film 3 containing the alkyl group as the elimination groups exhibits superior weather resistance and chemical resistance.

In a case where the elimination groups (organic groups) are methyl groups (—CH₃), an amount of the methyl groups is obtained from an intensity of a peak derived from the methyl groups in an infrared absorption spectrum which is obtained by subjecting the plasma polymerization film 3 to an infrared absorption measurement by using an infrared absorption measurement apparatus as follows.

In the infrared absorption spectrum of polyorganosiloxane, when an intensity of a peak derived from siloxane bonds is defined as “1”, the intensity of the peak derived from the methyl groups is preferably in the range of about 0.05 to 0.45, more preferably in the range of about 0.1 to 0.4 and even more preferably in the range of about 0.2 to 0.3. By setting the intensity of the peak derived from the methyl groups with respect to the peak derived from the siloxane bonds to a value within the above range, it is possible to prevent the methyl groups from interfering the production of the siloxane bonds more than necessary.

Further, since a necessary and sufficient number of the active hands are formed in silicon atoms of the Si-skeleton included in the plasma polymerization film 3 (polyorganosiloxane), sufficient bonding property is developed for the plasma polymerization film 3. Furthermore, sufficient weather property and chemical property are given to the plasma polymerization film 3 due to bonding of the methyl groups to the silicon atoms.

On the other hand, the organic metallic polymer is generated superior conductive property by performing the active treatment, so that it is possible to firmly bond the two base members together, namely the first base member 21 and the second base member 22. Therefore, it is possible for the plasma polymerization film 3 constituted of the organic metallic polymer to form a bonded body 1 which is capable of using as wires having high reliability by performing the active treatment described later. Such wires can prevent the peeling and the like reliably.

Among the organic metallic polymer, polymers of trimethylgallium and trimethylaluminium are particularly preferable. These polymers in the organic metallic polymer can bond the first base member 21 and the second base member 22 firmly. Therefore, it is possible to generate high conductive property to the plasma polymerization film 3 by performing the active treatment.

In the plasma polymerization, a frequency of the high-frequency voltage applied to across the first electrode 130 and the second electrode 140 is not particularly limited to a specific value, but is preferably in the range of about 1 kHz to 100 MHz and more preferably in the range of about 10 to 60 MHz.

An output density of the high-frequency voltage is not particularly limited to a specific value, but is preferably in the range of about 0.01 to 100 W/cm², more preferably in the range of about 0.1 to 50 W/cm² and even more preferably in the range of about 1 to 40 W/cm².

By setting the output density of the high-frequency voltage to a value within the above range, it is possible to reliably form plasma polymerization film 3 while preventing excessive plasma energy from being applied to the raw gas due to too high output density of the high-frequency voltage.

If the output density of the high-frequency voltage is smaller than the lower limit value noted above, the molecules contained in the raw gas can not be polymerized. Therefore, there is a possibility that the plasma polymerization film 3 can not be formed.

On the other hand, if the output density of the high-frequency voltage exceeds the upper limit value noted above, the molecules contained in the raw gas is decomposed and the elimination groups are eliminated from the silicon atoms of the Si-skeleton included in polyorganosiloxane (plasma polymerization film 3). As a result, there are possibilities that a content of the elimination groups included in the obtained plasma polymerization film 3 is greatly lowered and the bonding strength of the plasma polymerization film 3 is reduced.

An inside pressure of the chamber 101 during the deposition is in the range of about 133.3×10⁻⁵ to 1333 Pa (1×10⁻⁵ to 10 Torr) and more preferably in the range of about 133.3×10⁻⁴ to 133.3 Pa (1×10⁻⁴ to 1 Torr).

A flow rate of the raw gas is in the range of about 0.5 to 200 sccm and more preferably in the range of about 1 to 100 sccm. A flow rate of the carrier gas is in the range of about 5 to 750 sccm and more preferably in the range of about 10 to 500 sccm.

A time required for the deposition is in the range of about 1 to 10 minutes and more preferably in the range of about 4 to 7 minutes. A temperature of the first base member 21 is preferably 25° C. or higher and more preferably in the range of about 25 to 100° C.

By appropriately setting such conditions, it is possible to uniformly form a dense plasma polymerization film 3

In this embodiment, the description was made on the step in which the plasma polymerization film 3 is formed on the surface 23 of the first base member 21. However, the step may be a step that base member (first object) having a plasma polymerization film is preliminarily provided, and then the first object is used.

Further, an average thickness of the plasma polymerization film 3 is preferably in the range of about 10 to 10000 nm, and more preferably in the range of about 50 to 5000 nm. By setting the average thickness of the plasma polymerization film 3 to the above range, it is possible to prevent dimensional accuracy of the bonded body 1 obtained by bonding the first base member 21 and the second base member 22 together through the plasma polymerization film 3 from being significantly lowered, thereby enabling to more firmly bond them together.

If the average thickness of the plasma polymerization film 3 is lower than the above lower limit value, there is a case that the bonded body 1 having sufficient bonding strength cannot be obtained. In contrast, if the average thickness of the plasma polymerization film 3 exceeds the above upper limit value, there is a fear that dimensional accuracy of the bonded body 1 is lowered significantly.

In addition, in the case where the average thickness of the plasma polymerization film 3 is set to the above range, shape following property of the plasma polymerization film 3 is ensured. Even if irregularities exist on the bonding surface 23 (a surface to be adjoined to the plasma polymerization film 3) of the first base member 21, the plasma polymerization film 3 can be formed so as to assimilate the irregularities of the bonding surface 23 of the first base member 21, though it may be affected depending on sizes (heights) thereof.

As a result, it is possible to suppress sizes of irregularities of the surface 31 of the plasma polymerization film 3, which would be generated according to the irregularities of the bonding surface 23 of the first base member 21, from being extremely enlarged. Namely, it is possible to improve flatness of the surface 31 of the plasma polymerization film 3.

The thicker the thickness of plasma polymerization film 3 is, the higher degrees of the above flatness of the surface 31 and the shape following property of the plasma polymerization film 3 become. Therefore, it is preferred that the thickness of the plasma polymerization film 3 may be as thick as possible in order to further improve the degrees of the flatness of the surface 31 and the shape following property of the plasma polymerization film 3.

[3] Next, energy is applied to the surface 31 of the obtained plasma polymerization film 3. By doing so, a part of bonds positioned on the vicinity of the surface 31 to which the energy is applied is cut to activate the surface 31. This is referred to as the second step.

A method of applying energy to the surface 31 of the plasma polymerization film 3 is not particularly limited to a specific method as long as the surface 31 is activated, but a method of applying energy beam to the plasma polymerization film 3 is preferable. According to such a method, the surface 31 of the plasma polymerization film 3 can be activated efficiently.

In addition, according to such a method, it is possible to prevent performance of the plasma polymerization film 3 from being lowered. This is because the bonds included in the chemical structure of the plasma polymerization film 3 are not cut more than necessary (e.g. the bonds between the surface 23 of the first base member 21 and surface 31).

Examples of the energy beam include: a light such as an ultraviolet light and a laser light; an electron beam; a particle beam; and the like.

Among these energy beams mentioned above, it is particularly preferred that the ultraviolet light having a wavelength in the range of about 150 to 300 nm is used as shown in FIG. 2D. The use of such an ultraviolet light makes it possible to uniformly treat a large region of the surface 31 of the plasma polymerization film 3 for a short period of time while preventing the performance of the plasma polymerization film 3 from being greatly lowered.

Therefore, the activation of the surface 31 of the plasma polymerization film 3 can be performed more efficiently. Moreover, such an ultraviolet light has, for example, an advantage that it can be generated by simple equipment such as an UV lamp.

In this regard, it is to be noted that the wavelength of the ultraviolet light is more preferably in the range of about 160 to 200 nm.

Further, a time for irradiating the ultraviolet light is preferably set to enough time to cut the bonds (eliminate the elimination groups) from the vicinity of the surface 31 of the plasma polymerization film 3.

Such a time is not limited to a specific time, but is preferably in the range of about 0.5 to 30 minutes and more preferably in the range of about 1 to 10 minutes.

Further, the irradiation of the energy beam on the plasma polymerization film 3 may be performed in any atmosphere. The irradiation is particularly preferably performed in the atmosphere. As a result, it becomes unnecessary to spend labor hour and additional costs for controlling the atmosphere. This makes it possible to easily perform (carry out) the irradiation of the energy beam.

Hydroxyl groups (OH groups) are naturally bonded to the active bonds in the surface 31 of the activated plasma polymerization film 3 by being in contact with moisture around it.

In this regard, it is to be noted that the phrase “the plasma polymerization film 3 is activated” means any one of the following states. The first state is a state that the elimination groups bonded to the silicon atoms in the vicinity of the surface 31 and the inside of the plasma polymerization film 3 are eliminated (cut), thereby generating bonding hands not to be end-capped in the silicon atoms of the Si-skeleton (hereinafter simply referred to as “dangling-bond”).

The second state is a state that the bonding hands are end-capped by the hydroxyl groups. The third state is a state that the first state and the second state are co-existed.

In a case where the plasma polymerization film 3 is constituted of the organic metallic polymer, if the energy is applied to the plasma polymerization film 3, an organic component is removed from the plasma polymerization film 3. Therefore, a conductive component exists in the plasma polymerization film 3 in a rich state. As a result, conductive property is generated to the plasma polymerization film 3 to which the energy has been applied (the active treatment is performed).

[4] Next, a second base member is provided. The second base member does not have a plasma polymerization film onto the surface thereof to be bonded to the surface 31 of the first object (including the first base member 21 and the plasma polymerization film 3). In this embodiment, the second base member is a second base member 22 having no plasma polymerization film.

Then, the second base member 22 is bonded to the surface 31 of the plasma polymerization film 3 so as to be in contact with the surface 31 of the plasma polymerization film 3 activated in the step [3] and the surface of the second base member 22 (see FIG. 3E).

By doing so, the second base member 22 is bonded to the activated surface of the plasma polymerization film 3 formed on the first base member 21. As a result, a bonded body 1 is obtained. This is referred to as the third step.

The constituent materials of the first base member 21 and the second base member 22 may be the same or different from each other.

The thermal expansion coefficients of the first base member 21 and the second base member 22 is preferably substantially the equal to each other, but may be different from each other.

In the case where the first base member 21 and the second base member 22 have the substantially equal thermal expansion coefficients with each other, when the first base member 21 and the second base member 22 are bonded to each other, stress due to thermal expansion is less easily generated on a bonding interface therebetween. As a result, it is possible to reliably prevent occurrence of peeling in the bonded body 1 finally obtained.

As described in detail below, even if first base member 21 and the second base member 22 have the different thermal expansion coefficients with each other, by optimizing conditions for bonding between the first base member 21 and the second base member 22 in the after step, they can be firmly bonded together with high dimensional accuracy.

Furthermore, it is preferred that the first base member 21 and the second base member 22 have different rigidities. This makes it possible to more firmly bond the first base member 21 and the second base member 22 together through the plasma polymerization film 3.

Moreover, it is preferred that at least one base member of the first base member 21 and the second base member 22 is composed of a resin material. The base member composed of the resin material can be easily deformed due to plasticity of the resin material itself.

Therefore, it is possible to reduce stress which would be generated on the bonding interface between the first base member 21 and the second base member 22 (e.g., stress due to thermal expansion thereof) when they are bonded together through the plasma polymerization film 3. As a result, breaking of the bonding interface becomes hard. This makes it possible to obtain a bonded body 1 having high bonding strength between the first base member 21 and the second base member 22.

In the thus obtained bonded body 1, the first base member 21 and the second base member 22 are not bonded to each other through the plasma polymerization film 3 by the bonding based on a physical bonding such as a anchor effect as an adhesive which has been used in a conventional bonding method, but by the bonding based on a firm chemical bonding such as a covalent bonding which generates for a short period of time. Therefore, the bonded body 1 is hardly peeled and such bonding is performed uniformly.

According to the bonding method of the present invention, since the thermal treatment at a high temperature (about 700 to 800° C.) is not needed as the conventional solid bonding, members constituted of materials having low heat resistance can be also used for the bonding method of the present invention. This makes it possible to use various kinds of constituent material for the members.

Furthermore, according to the bonding method of the present invention, the plasma polymerization film 3 is formed on only the surface 31 of the first base member 21 of the two base members 21 and 22, thereby constituting the first object. In this first object, although the first base member 21 is exposed by plasma for a relative long period of time during the formation of the plasma polymerization film 3, the second base member 22 is not exposed by the plasma.

Therefore, even if durability of the second base member 22 to the plasma is greatly low, it is possible to firmly bond the first base member 21 and the second base member 22 together through the plasma polymerization film 3 according to the bonding method of the present invention. In view of the above, the second base member 22 has an advantage that the constituent material thereof can be used form various kinds of materials regardless of the durability to the plasma.

It is preferred that hydroxyl groups (OH groups) are bonded to a region of the surface of the second base member 22 which is in contact with the plasma polymerization film 3 formed on the first base member 21 in this step. In other words, it is preferred that the hydroxyl groups (OH groups) are bonded to the region of the surface of the second base member 22 to be bonded to the plasma polymerization film 3.

Such a state of the region of the surface of the second base member 22 makes it possible to increase the bonding strength between the plasma polymerization film 3 and second base member 22, so that it is possible to more firmly bond the first base member 21 and the second base member 22 together through the plasma polymerization film 3. In this regard, it is to be noted that it is considered that such effects are exhibited by the following phenomenon.

In this process, when the surface 31 of the plasma polymerization film 3 are in contact with (adheres to) the surface of the second base member 22, the hydroxyl groups existing on the surface of the second base member 22 and the hydroxyl groups existing on the activated surface 31 of the plasma polymerization film 3 are attracted to each other by hydrogen bonds. As a result, attracting force is generated between the attracted hydroxyl groups.

Depending on conditions such as a temperature and the like, the hydroxyl groups attracted by the hydrogen bonds are dehydrated and condensed, so that the hydroxyl groups and/or water molecules are removed from the bonding surface (the contact surface) between the plasma polymerization film 3 and the second base member 22.

As a result, two atoms (bonding hands), to which the hydroxyl groups had been bonded, are bonded to each other directly. In this way, it is considered that the plasma polymerization film 3 and the second base member 22 are chemically firmly bonded to each other.

In order to make a state that the hydroxyl groups are bonded to the region of the surface of the second base member 22 to be bonded to the surface 31 of the plasma polymerization film 3, a method (surface treatment) is not limited to a specific method.

Examples of such a method include: a method of subjecting the surface of the second base member 22 to a plasma treatment using oxygen plasma; a method of subjecting the surface of the second base member 22 to a etching treatment; a method of applying electron beam to the surface of the second base member 22; a method of irradiating ultraviolet light to the surface of the second base member 22; a method of exposing the surface of the second base member 22 to ozone gas; a combination method of these method, and the like.

The use of such a method makes it possible to clean the surface of the second base member 22 and cut some bonds existing on the vicinity of the surface to activate the surface thereof, namely obtain bonding hands. The hydroxyl groups (OH groups) are naturally bounded to the bonding hands existing on the surface thereof in such a state of being in contact with moisture around them. In this way, it is possible to form a state that the hydroxyl groups are bonded to the bonding hands.

Depending on the constituent material of the second base member 22, the hydroxyl groups are bonded to the surface thereof even if the surface of the second base member 22 is not subjected to the surface treatment described above.

Examples of the constituent material of the second base member 22 include: various kinds of metal-based materials such as stainless steel, and aluminum; various kinds of silicon-based materials such as silicon and quartz glass; various kinds of oxide-based ceramics materials such as alumina; and the like.

In this case, the whole of the second base member 22 may not be constituted of the above materials, as long as at least the region of the surface of the second base member 22 where the plasma polymerization film 3 is to be formed is constituted of the above materials.

The surface of the second base member 22 formed of such materials is covered with an oxide film. In the oxide film, the hydroxyl groups exist in the surface thereof. Therefore, by using the second base member 22 covered with such an oxide film, it is possible to firmly bond the second base member 22 and the plasma polymerization film 3 together without subjecting the surface of the second base member 22 to the surface treatment of exposing the hydrogen groups described above.

The active bonding hands (dangling bonds) not to be end-capped which are obtained by cutting the bonds of the constituent materials of the second base member 22 may be included in the vicinity of the surface of the second base member 22 and in the inside thereof.

Besides, the surface and the inside of the second base member 22 may be a mixing state of the hydroxyl groups and the dangling bonds. That is, both the hydroxyl groups and the dangling bonds exist on the surface of the second base member 22 and in the inside thereof.

If the dangling bonds are included on the surface of the second base member 22 and in the inside thereof, firm bonding which is derived from a covalent bonding formed in a network status is made between the dangling bonds of the surface 31 of the plasma polymerization film 3 and the surface of the second base member 22. As a result, it is possible to more firmly bond the first base member 21 and the second base member 22 together through the plasma polymerization film 3.

In this regard, it is to be noted that an active state of the surface 31 of the plasma polymerization film 3 activated in the step [3] described above is reduced over time. Therefore, after completion of the step [3] described above, this step [4] should be performed as soon as possible. That is, after completion of the step [3] described above, this step [4] is preferably performed within 60 minutes, and more preferably within 5 minutes.

By performing the step [4] within such a time, it is possible to obtain sufficient bonding strength when the second base member 22 is bonded to the plasma polymerization film 3. This is because the active state of the surface 31 of the plasma polymerization film 3 is maintained sufficiently.

In other words, the plasma polymerization film 3 before it is activated is chemically stable and exhibits superior weather resistance. For these reasons, the plasma polymerization film 3 at the time of the completion of the step [2] described above is stable for storage or preservation for long period of time.

Therefore, the first base member 21 provided with the such a plasma polymerization film 3, namely a large number of first object is produced or purchased to store or preserve, and then only a needed number of the objects is subjected to the step [3] described above just before bonding the second base member 22 and the plasma polymerization film 3 in this step [4]. By doing so, the performance of the step [4] within the time described above is effective from a view point of productive efficiency of the bonded body 1.

In this regard, even if the surfaces of a base member and a plasma polymerization film are activated in the solid bonding method as a conventional silicon directly-bonding method, such an active state is maintained for only a very short period of time, namely in the range of about a few seconds to several tens of seconds, in an atmosphere. Therefore, after activating the surfaces, there is a problem in that a time of work of attaching two base members to be bonded together cannot be ensured sufficiently.

In contrast, according to the present invention, the active state can be maintained for relatively a long period of time, namely more than a few minutes, due to the plasma polymerization film 3. Therefore, labor hour can be ensured sufficiently, thereby enabling efficiency of the bonding work to improve.

As described above, the bonded body 1 (bonded body of the present invention) can be obtained.

In the bonded body 1 obtained in this way, the bonding strength between the first base member 21 and the second base member 22 through the plasma polymerization film 3 is preferably equal to or larger than 5 MPa (50 kgf/cm²) and more preferably equal to or larger than 10 MPa (100 kgf/cm²).

Therefore, peeling off of the second base member 22 and the plasma polymerization film 3 can be sufficiently prevented due to the bonded body 1 having such a bonding strength. As described later, in a case where a droplet ejection head is formed using the bonded body 1, it is possible to obtain a droplet ejection head having excellent durability.

Furthermore, according to the bonding method of the present invention, it is possible to efficiently produce a bonded body 1 in which the first base member 21 is bonded to the second base member 22 through the plasma polymerization film 3 in a large bonding strength described above.

In a case where the plasma polymerization film 3 is constituted of the organic metallic polymer, conductive property is generated by subjecting the surface 31 of the plasma polymerization film 3 to the active treatment (surface treatment). A resistivity of the plasma polymerization film 3 subjected to such an active treatment is preferably 1×10⁻³ Ω·cm or lower and more preferably 1×10⁻⁴ Ω·cm or lower.

If the resistivity of the plasma polymerization film 3 of which the conductive property is generated by subjecting to the active treatment is too low as the above value, such a plasma polymerization film 3 can be sufficiently utilized as wires having less loss.

Though depending on a thickness of the plasma polymerization film 3, it has relatively high translucency. By appropriately adjusting conditions of forming the plasma polymerization film 3 (conditions of the plasma polymerization and a composition of raw gases), it is possible to adjust a refractive index of the plasma polymerization film 3. To be concrete, by improving output density of the high-frequency voltage to be applied across the first electrode 130 and the second electrode 140 in the plasma polymerization method, it is possible to improve the refractive index of the plasma polymerization film 3.

On the contrary, by reducing output density of the high-frequency voltage to be applied across the first electrode 130 and the second electrode 140 in the plasma polymerization method, it is possible to reduce the refractive index of the plasma polymerization film 3.

According to the plasma polymerization method in which silane-based gases are used as the raw gas, the plasma polymerization film 3 of which refractive index is in the range of about 1.35 to 1.6 is obtained. Since the refractive index of such a plasma polymerization film 3 is close to those of a crystal and a quartz glass, the plasma polymerization film 3 is preferably used for the production of optical elements having a structure that light passes through the plasma polymerization film 3. Further, since the refractive index of the plasma polymerization film 3 can be adjusted, it is possible to produce a plasma polymerization film 3 having a predetermined refractive index.

After the bonded body 1 has been obtained, if necessary, at least one step (a step of increasing bonding strength between parts of the head 1) of two steps (steps [5A] and [5B]) described below may be carried out to the bonded body 1.

<5A> As shown in FIG. 3G, the obtained bonded body 1 are then pressed to a direction in which the first base member 21 and the second base member 22 approach to each other.

As a result, the surface of the plasma polymerization film 3 comes closer to the surface of the second base member 22. It is possible to further increase the bonding strength between the plasma polymerization film 3 and the second base member 22 in the bonded body 1.

At this time, it is preferred that a pressure in pressing the bonded body 1 is as large as possible. This makes it possible to increase bonding strength between the plasma polymerization film 3 and the second base member 22 in the bonded body 1 according to an increased degree of this pressure.

In this regard, it is to be noted that this pressure can be appropriately adjusted, depending on the constituent materials and thicknesses of the first base member 21 and the second base member 22, conditions of a bonding apparatus, and the like.

Specifically, the pressure is preferably in the range of about 1 to 10 MPa and more preferably in the range of about 1 to 5 MPa, although being slightly different depending on the constituent materials and thicknesses of the first base member 21 and the second base member 22, and the like.

By setting the pressure to the above range, it is possible to reliably increase bonding strength between the plasma polymerization film 3 and the second base member 22 in the bonded body 1. Further, although the pressure may exceed the above upper limit value, there is a fear that damages and the like occur in the first base member 21 and the second base member 22, depending on the constituent materials thereof.

A time for pressing the bonded body 1 is not particularly limited to a specific value, but is preferably for a length of time from about 10 seconds to 30 minutes. The pressing time can be appropriately changed, depending on the pressure for pressing the bonded body 1. Specifically, in the case where the pressure in pressing the bonded body 1 is larger, it is possible to increase bonding strength between the plasma polymerization film 3 and the second base member 22 in the bonded body 1 even if the pressing time becomes short.

[5B] As shown in FIG. 3G, the obtained bonded body 1 is heated.

This makes it possible to more increase bonding strength between the plasma polymerization film 3 and the second base member 22 in the bonded body 1. A temperature in heating the bonded body 1 is not particularly limited to a specific value, as long as the temperature is higher than room temperature and lower than a heat resistant temperature of the bonded body 1.

Specifically, the temperature is preferably in the range of about 25 to 100° C. and more preferably in the range of about 50 to 100° C. If the bonded body 1 is heated at the temperature of the above range, it is possible to reliably increase bonding strength between the plasma polymerization film 3 and the second base member 22 in the bonded body 1 while reliably preventing them from being thermally altered and deteriorated.

Further, a heating time is not particularly limited to a specific value, but is preferably for a length of time from about 1 to 30 minutes.

In a case where both steps [5A] and [5B] are performed, the steps are preferably performed simultaneously. In other words, the bonded body 1 is preferably heated while being pressed as shown in FIG. 3G. By doing so, an effect by pressing and an effect by heating are exhibited synergistically. Therefore, it is possible to particularly increase bonding strength between the plasma polymerization film 3 and the second base member 22 in the bonded body 1.

In a case where the thermal expansion coefficients of the first base member 21 and the second base member 22 are substantially the equal to each other, the bonded body 1 is preferably heated as described above. However, in a case where the thermal expansion coefficients of the first base member 21 and the second base member 22 are different from each other, it is preferred that the heating process is performed at as low temperature as possible.

By performing the heating process at the low temperature, it is possible to further reduce thermal stress which would be generated on the bonding interface between the plasma polymerization film 3 and the second base member 22.

Specifically, the first base member 21 and the second base member 22 are bonded together in a state that each of the first base member 21 and the second base member 22 is heated preferably at a temperature of about 25 to 50° C., and more preferably at a temperature of about 25 to 40° C., although being different depending on the difference between the thermal expansion coefficients thereof.

In such a temperature range, even if the difference between the thermal expansion coefficients of the first base member 21 and the second base member 22 is rather large, it is possible to sufficiently reduce thermal stress which would be generated on the bonding interface between the plasma polymerization film 3 and the second base member 22. As a result, it is possible to reliably suppress or prevent occurrence of warp (warpage), peeling or the like in the bonded body 1.

Especially, in the case where the difference between the thermal expansion coefficients of the first base member 21 and the second base member 22 is equal to or larger than 5×10⁻⁵/K, it is particularly recommended that the plasma polymerization film 3 and the second base member 22 are bonded to each other at a low temperature as much as possible as described above.

The performance of the steps described above makes it possible to further increase the bonding strength between the plasma polymerization film 3 and the second base member 22 in the bonded body 1.

Droplet Ejection Head

Now, a description will be made on an embodiment of a droplet ejection head in which the bonded body according to the present invention is used.

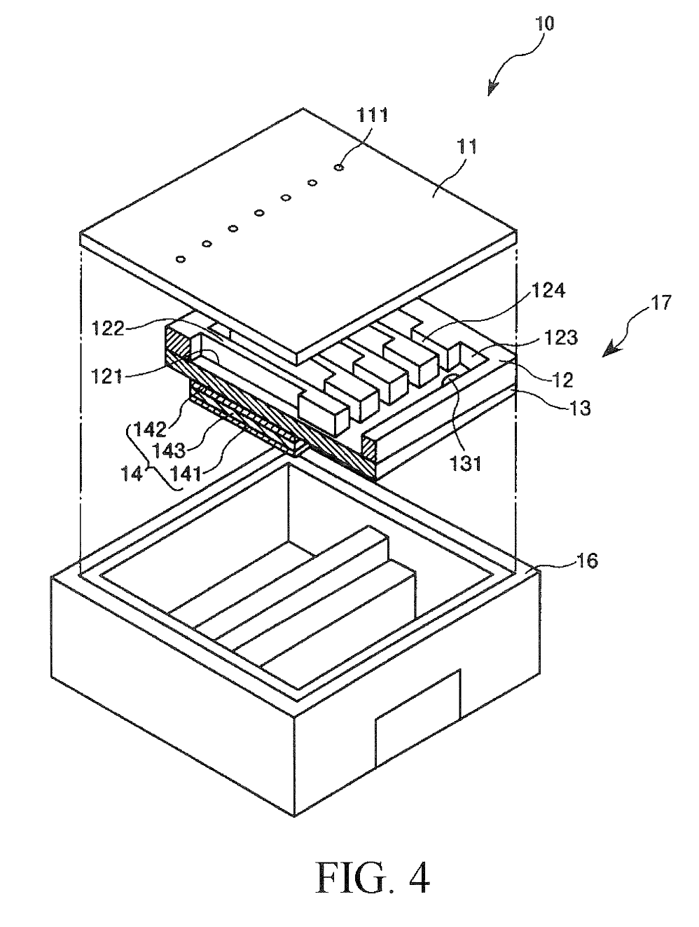

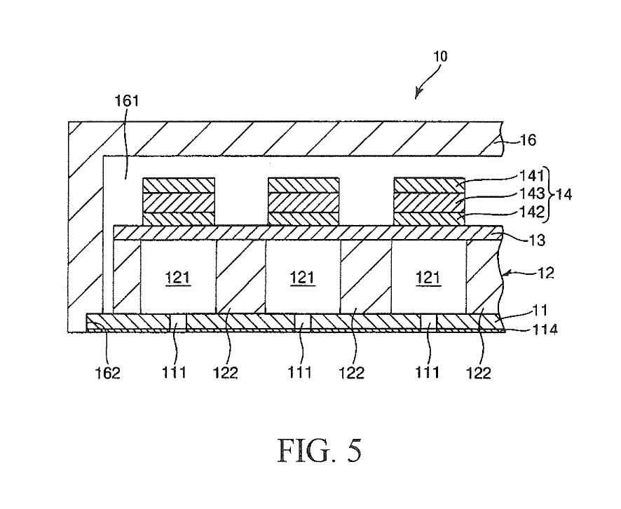

FIG. 4 is an exploded perspective view showing an ink jet type recording head (a droplet ejection head) in which the bonded body according to the present invention is used. FIG. 5 is a section view illustrating major parts of the ink jet type recording head shown in FIG. 4.

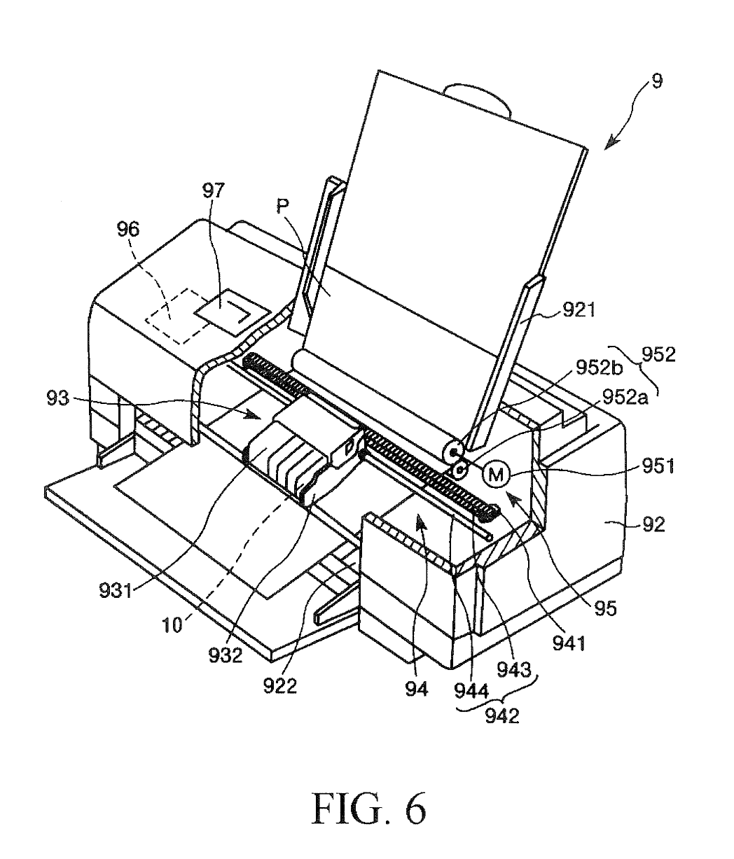

FIG. 6 is a schematic view showing one embodiment of an ink jet printer equipped with the ink jet type recording head shown in FIG. 4. In FIG. 4, the ink jet type recording head is shown in an inverted state as distinguished from a typical use state.

The ink jet type recording head (droplet ejection head according to the present invention) 10 shown in FIG. 4 is mounted to the ink jet printer (droplet ejection apparatus according to the present invention) 9 shown in FIG. 6.

The ink jet printer 9 shown in FIG. 6 includes a printer body 92, a tray 921 provided in the upper rear portion of the printer body 92 for holding recording paper sheets P, a paper discharging port 922 provided in the lower front portion of the printer body 92 for discharging the recording paper sheets P therethrough, and an operation panel 97 provided on the upper surface of the printer body 92.

The operation panel 97 is formed from, e.g., a liquid crystal display, an organic EL display, an LED lamp or the like. The operation panel 97 includes a display portion (not shown) for displaying an error message and the like and an operation portion (not shown) formed from various kinds of switches.

Within the printer body 92, there are provided a printing device (a printing means) 94 having a reciprocating head unit 93, a paper sheet feeding device (a paper sheet feeding means) 95 for feeding the recording paper sheets P into the printing device 94 one by one and a control unit (a control means) 96 for controlling the printing device 94 and the paper sheet feeding device 95.

Under the control of the control unit 96, the paper sheet feeding device 95 feeds the recording paper sheets P one by one in an intermittent manner. The recording paper sheet P passes near the lower portion of the head unit 93. At this time, the head unit 93 makes reciprocating movement in a direction generally perpendicular to the feeding direction of the recording paper sheet P, thereby printing the recording paper sheet P.

In other words, an ink jet type printing operation is performed, during which time the reciprocating movement of the head unit 93 and the intermittent feeding of the recording paper sheets P act as primary scanning and secondary scanning, respectively.

The printing device 94 includes a head unit 93, a carriage motor 941 serving as a driving power source of the head unit 93 and a rotated by the carriage motor 941 for reciprocating the head unit 93.

The head unit 93 includes an ink jet type recording head 10 (hereinafter, simply referred to as “a head 10”) having a plurality of formed in the lower portion thereof, an ink cartridge 931 for supplying ink to the head 10 and a carriage 932 carrying the head 10 and the ink cartridge 931.

Full color printing becomes available by using, as the ink cartridge 931, a cartridge of the type filled with ink of four colors, i.e., yellow, cyan, magenta and black.

The reciprocating mechanism 942 includes a carriage guide shaft 943 whose opposite ends are supported on a frame (not shown) and a timing belt 944 extending parallel to the carriage guide shaft 943.

The carriage 932 is reciprocatingly supported by the carriage guide shaft 943 and fixedly secured to a portion of the timing belt 944.

If the timing belt 944 wound around a pulley is caused to run in forward and reverse directions by operating the carriage motor 941, the head unit 93 makes reciprocating movement along the carriage guide shaft 943. During this reciprocating movement, an appropriate amount of ink is ejected from the head 10 to print the recording paper sheets P.

The paper sheet feeding device 95 includes a paper sheet feeding motor 951 serving as a driving power source thereof and a pair of paper sheet feeding rollers 952 rotated by means of the paper sheet feeding motor 951.

The paper sheet feeding rollers 952 include a driven roller 952a and a driving roller 952b, both of which face toward each other in a vertical direction, with a paper sheet feeding path (the recording paper sheet P) remained therebetween. The driving roller 952b is connected to the paper sheet feeding motor 951.

Thus, the paper sheet feeding rollers 952 are able to feed the plurality of recording paper sheets P, which are held in the tray 921, toward the printing device 94 one by one. In place of the tray 921, it may be possible to employ a construction that can removably hold a paper sheet feeding cassette containing the recording paper sheets P.

The control unit 96 is designed to perform printing by controlling the printing device 94 and the paper sheet feeding device 95 based on the printing data inputted from a host computer, e.g., a personal computer or a digital camera.

Although not shown in the drawings, the control unit 96 is mainly comprised of a memory that stores a control program for controlling the respective parts and the like, a piezoelectric element driving circuit for driving piezoelectric elements (vibration sources) 14 to control an ink ejection timing, a driving circuit for driving the printing device 94 (the carriage motor 941), a driving circuit for driving the paper sheet feeding device 95 (the paper sheet feeding motor 951), a communication circuit for receiving printing data from a host computer, and a CPU electrically connected to the memory and the circuits for performing various kinds of control with respect to the respective parts.

Electrically connected to the CPU are a variety of sensors capable of detecting, e.g., the remaining amount of ink in the ink cartridge 931 and the position of the head unit 93.

The control unit 96 receives printing data through the communication circuit and then stores them in the memory. The CPU processes these printing data and outputs driving signals to the respective driving circuits, based on the data thus processed and the data inputted from the variety of sensors. Responsive to these signals, the piezoelectric elements 14, the printing device 94 and the paper sheet feeding device 95 come into operation, thereby printing the recording paper sheets P.

Hereinafter, the head (droplet ejection head according to the present invention) 10 will be described in detail with reference to FIGS. 4 and 5.

The head 10 includes a head main body 17 and a base body 16 for receiving the head main body 17. The head main body 17 includes a nozzle plate 11, an ink chamber base plate 12, a vibration plate 13 and a plurality of piezoelectric elements (vibration sources) 14 bonded to the vibration plate 13. The head 10 constitutes a piezo jet type head of on-demand style.

The nozzle plate 11 is made of, e.g., a silicon-based material such as SiO₂, SiN or quartz glass, a metallic material such as Al, Fe, Ni, Cu or alloy containing these metals, an oxide-based material such as alumina or ferric oxide, a carbon-based material such as carbon black or graphite. and the like.

A plurality of nozzle holes 111 for ejecting ink droplets therethrough is formed in the nozzle plate 11. The pitch of the nozzle holes 111 is suitably set according to the degree of printing accuracy.

The ink chamber base plate 12 is fixed or secured to the nozzle plate 11. In the ink chamber base plate 12, there are formed a plurality of ink chambers (cavities or pressure chambers) 121, a reservoir chamber 123 for reserving ink supplied from the ink cartridge 931 and a plurality of supply ports 124 through which ink is supplied from the reservoir chamber 123 to the respective ink chambers 121. These chambers 121, 123 and 124 are defined by the nozzle plate 11, the side walls (barrier walls) 122 and the below mentioned vibration plate 13.

The respective ink chambers 121 are formed into a reed shape (a rectangular shape) and are arranged in a corresponding relationship with the respective nozzle holes 111. Volume of each of the ink chambers 121 can be changed in response to vibration of the vibration plate 13 as described below. Ink is ejected from the ink chambers 121 by virtue of this volume change.

As a base material of which the ink chamber base plate 12 is made, it is possible to use, e.g., a monocrystalline silicon substrate, various kinds of glass substrates or various kinds of resin substrates. Since these substrates are all generally used in the art, use of these substrates makes it possible to reduce manufacturing cost of the head 10.

The vibration plate 13 is bonded to the opposite side of the ink chamber base plate 12 from the nozzle plate 11. The plurality of piezoelectric elements 14 are provided on the opposite side of the vibration plate 13 from the ink chamber base plate 12.

In a predetermined position of the vibration plate 13, a communication hole 131 is formed through a thickness of the vibration plate 13. Ink can be supplied from the ink cartridge 931 to the reservoir chamber 123 through the communication hole 131.

Each of the piezoelectric elements 14 includes an upper electrode 141, a lower electrode 142 and a piezoelectric body layer 143 interposed between the upper electrode 141 and the lower electrode 142. The piezoelectric elements 14 are arranged in alignment with the generally central portions of the respective ink chambers 121.

The piezoelectric elements 14 are electrically connected to the piezoelectric element driving circuit and are designed to be operated (vibrated or deformed) in response to the signals supplied from the piezoelectric element driving circuit.

The piezoelectric elements 14 act as vibration sources. The vibration plate 13 is vibrated by operation of the piezoelectric elements 14 and has a function of instantaneously increasing internal pressures of the ink chambers 121.

The base body 16 is made of, e.g., various kinds of resin materials or various kinds of metallic materials. The nozzle plate 11 is fixed to and supported by the base body 16. Specifically, in a state that the head main body 17 is received in a recess portion 161 of the base body 16, an edge of the nozzle plate 11 is supported on a shoulder 162 of the base body 16 extending along an outer circumference of the recess portion 161.

When bonding the nozzle plate 11 and the ink chamber base plate 12, the ink chamber base plate 12 and the vibration plate 13, and the nozzle plate 11 and the base body 16 as mentioned above, the bonding method of the present invention is used in at least one bonded portion thereof.

In other words, the bonded body 1 of the present invention is used in at least one of a bonded body in which the nozzle plate 11 and the ink chamber base plate 12 are bonded together, a bonded body in which the ink chamber base plate 12 and the vibration plate 13 are bonded together, and a bonded body in which the nozzle plate 11 and the base body 16 are bonded together.

In such a head 10, two members constituting each of them are bonded together through the plasma polymerization film 301 in the bonding interface. Therefore, the head 10 exhibits increased bonding strength and chemical resistance in bonding interfaces (the bonded portion), which in turn leads to increased durability and liquid tightness against the ink reserved in the respective ink chambers 121. As a result, the head 10 is rendered highly reliable.

Furthermore, highly reliable bonding is available even at an extremely low temperature. There is an advantage that a head with an increased area can be fabricated from members made of materials having different linear expansion coefficients.

Moreover, in the case where the bonded body 1 of the present invention is used in a part of the head 10, it is possible to manufacture a head 10 having high dimensional accuracy. Therefore, it is possible to control an ejecting direction of ink droplets ejected from the head 10, and a distance between the head 10 and each of the recording paper sheets P with high accuracy. This makes it possible to improve a quality of a printing recorded using the ink jet printer 9 provided with such a head 10.

With the head 10 set forth above, no deformation occurs in the piezoelectric body layer 143, in the case where a predetermined ejection signal has not been inputted from the piezoelectric element driving circuit, that is, a voltage has not been applied between the upper electrode 141 and the lower electrode 142 of each of the piezoelectric elements 14.

For this reason, no deformation occurs in the vibration plate 13 and no change occurs in the volumes of the ink chambers 121. Therefore, the ink droplets have not been ejected from the nozzle holes 111.

On the other hand, the piezoelectric body layer 143 is deformed, in the case where the predetermined ejection signal is inputted from the piezoelectric element driving circuit, that is, the voltage is applied between the upper electrode 141 and the lower electrode 142 of each of the piezoelectric elements 14.

Thus, the vibration plate 13 is heavily deflected to change the volumes of the ink chambers 121. At this moment, pressures within the ink chambers 121 are instantaneously increased and the ink droplets are ejected from the nozzle holes 111.

When one ink ejection operation has ended, the piezoelectric element driving circuit ceases to apply the voltage between the upper electrode 141 and the lower electrode 142. Thus, the piezoelectric elements 14 are returned substantially to their original shapes, thereby increasing the volumes of the ink chambers 121.

At this time, a pressure acting from the ink cartridge 931 toward the nozzle holes 111 (a positive pressure) is imparted to the ink. This prevents an air from entering the ink chambers 121 through the nozzle holes 111, which ensures that the ink is supplied from the ink cartridge 931 (the reservoir chamber 123) to the ink chambers 121 in a quantity corresponding to the quantity of the ink ejected.

By sequentially inputting ejection signals from the piezoelectric element driving circuit to the piezoelectric elements 14 lying in target printing positions, it is possible to print an arbitrary (desired) letter, figure or the like.

The head 10 may be provided with thermoelectric conversion elements in place of the piezoelectric elements 14. In other words, the head 10 may have a configuration in which the ink is ejected using a thermal expansion of a material caused by the thermoelectric conversion elements (which is sometimes called a bubble jet method wherein the term “bubble jet” is a registered trademark).

In the head 10 configured as above, a film 114 is formed on the nozzle plate 11 in an effort to impart liquid repellency thereto. By doing so, it is possible to reliably prevent the ink droplets from adhering to peripheries of the nozzle holes 111, which would otherwise occur when the ink droplets are ejected from the nozzle holes 111.

As a result, it becomes possible to make sure that the ink droplets ejected from the nozzle holes 111 are reliably landed (hit) on target regions.

Although the bonding method and the bonded body according to the present invention has been described above based on the embodiments illustrated in the drawings, the present invention is not limited thereto. If necessary, one or more arbitrary step may be added in the bonding method according to the present invention.

It is needless to say that the bonded body according to the present invention can be used in other apparatuses than the droplet ejection apparatus as described in the embodiment. Examples of the other apparatuses include a semiconductor apparatus, a MEMS, a microreactor and the like.

### EXAMPLES

Next, a description will be made on a number of concrete examples of the present invention.

1. Manufacturing of Bonded Body

Hereinafter, 20 bonded bodies were produced in each of the Examples 1 to 17 and the Comparative Examples 1 to 11.

### Example 1

First, a monocrystalline silicon substrate having a length of 20 mm, a width of 20 mm and an average thickness of 1 mm was prepared as a first base member. A glass substrate having a length of 20 mm, a width of 20 mm and an average thickness of 1 mm was also prepared as a second base member.

Subsequently, the monocrystalline silicon substrate (first base member) was set in the chamber 101 of the plasma polymerization apparatus 100 shown in FIG. 1 and subjected to a surface treatment using oxygen plasma.

Next, a plasma polymerization film having an average thickness of 200 nm was formed on the surface-treated surfaces of the monocrystalline silicon substrate. In this regard, it is to be noted that the film forming conditions were as follows.

Film Forming Conditions

Composition of raw gas: octamethyltrisiloxane

Flow rate of raw gas: 50 sccm

Composition of carrier gas: argon gas

Flow rate of carrier gas: 100 sccm

Output of high-frequency electricity: 100 W Output density of the high-frequency voltage: 25 W/cm²

Pressure within chamber during film formation: 1 Pa (low vacuum)

Processing time: 15 minutes

Temperature of substrate: 20° C.

Then, an ultraviolet ray was irradiated on the obtained plasma polymerization film under the following conditions.

Ultraviolet Ray Irradiation Conditions

Composition of atmospheric gas: atmosphere (air)

Temperature of atmospheric gas: 20° C.

Pressure of atmospheric gas: atmospheric pressure (100 kPa)

Wavelength of ultraviolet ray: 172 nm

Irradiation time of ultraviolet ray: 5 minutes

On the other hand, one surface of the glass substrate (second base member) was subjected to a surface treatment using oxygen plasma.

Subsequently, the monocrystalline silicon substrate and the glass substrate were laminated so that the ultraviolet ray-irradiated surface of the plasma polymerization film and the surface-treated surface of the glass substrate made contact with each other to thereby obtain a bonded body.

Then, the bonded body thus obtained was heated at a temperature of 80° C. while pressing the same under a pressure of 3 MPa and was maintained for fifteen minutes to thereby bond the plasma polymerization film and the glass substrate. In this way, the bonded body was obtained.

### Example 2

In Example 2, a bonded body was manufactured in the same manner as in the Example 1, except that the heating temperature was changed from 80° C. to 25° C. during the pressing and heating of the obtained bonded body.

### Examples 3 to 12

In each of Examples 3 to 12, a bonded body was manufactured in the same manner as in the Example 1, except that the constitute material of each of the first base member and the second base member was changed to materials shown in Table 1.

### Example 13

In Example 13, a bonded body was manufactured in the same manner as in the Example 1, except that the output of the high-frequency electricity was changed to 150 W (output density of the high-frequency voltage was changed 37.5 W/cm²).

### Example 14

In Example 14, a bonded body was manufactured in the same manner as in the Example 1, except that the output of the high-frequency electricity was changed to 200 W (output density of the high-frequency voltage was changed 50 W/cm²).

### Example 15

In the Example 15, a bonded body was manufactured in the same manner as in the Example 1, except that the composition of the raw gas was changed to trimethylgallium as shown in Table 1.

### Example 16

In the Example 16, a bonded body was manufactured in the same manner as in the Example 3, except that the composition of the raw gas was changed to trimethylgallium as shown in Table 1.

### Example 17

In the Example 17, a bonded body was manufactured in the same manner as in the Example 4, except that the composition of the raw gas was changed to trimethylgallium as shown in Table 1.

### Comparative Example 1

In the Comparative Example 1, a bonded body was manufactured in the same manner as in the Example 1, except that the first base member and the second base member were bonded to each other using an epoxy-based adhesive.

### Comparative Example 2

In the Comparative Example 2, a bonded body was manufactured in the same manner as in the Example 3, except that the first base member and the second base member were bonded to each other using an epoxy-based adhesive.

### Comparative Example 3

In the Comparative Example 3, a bonded body was manufactured in the same manner as in the Example 4, except that the first base member and the second base member were bonded to each other using an epoxy-based adhesive.

### Comparative Example 4

In the Comparative Example 4, a bonded body was manufactured in the same manner as in the Example 1, except that the following bonding film was formed on the first base member instead of the plasma polymerization film.

First, prepared was a liquid material which contains a material having a polydimethylsiloxane skeleton as a silicone material and toluene and isobutanol as a solvent (“KR-251” produced by Shin-Etsu Chemical Co., Ltd., a viscosity (at 25° C.) is 18.0 mPa·S).

Subsequently, after a surface of a monocrystalline silicon substrate was subjected to a surface treatment using oxygen plasma, the liquid material was applied onto the surface-treated surface of the monocrystalline silicon substrate. Next, the applied liquid material was dried at room temperature (25° C.) for 24 hours to obtain a bonding film.

Likewise, after a surface of a glass substrate was subjected to the surface treatment using the oxygen plasma, a bonding film was formed on the surface-treated surface. An ultraviolet ray was selectively irradiated at a frame-shaped region having a width of 3 mm along a periphery of the surface of each of the bonding films.

Thereafter, the monocrystalline silicon substrate and the glass substrate were heated while pressing them so that the bonding films are bonded to each other. In this way, a bonded body was obtained, in which the monocrystalline silicon substrate was bonded to the glass substrate through the bonding films.

### Comparative Examples 5 to 10

In each of the Comparative Examples 5 to 10, a bonded body was manufactured in the same manner as in the Comparative Example 4, except that the constituent material of each of the first base member and the second base member was changed to materials shown in Table 1.

### Comparative Example 11

In the Comparative Example 11, a bonded body was manufactured in the same manner as in the Example 1, except that the following bonding film was formed on the first base member instead of the plasma polymerization film.

First, after a surface of a monocrystalline silicon substrate was subjected to a surface treatment using oxygen plasma, a vapor of hexamethyldisilazane (HMDS) was selectively applied to a frame-shaped region having a width of 3 mm along a periphery of the surface-treated surface to obtain a bonding film constituted of HMDS.

Likewise, after a surface of a glass substrate was subjected to the surface treatment using the oxygen plasma, a bonding film constituted of HMDS was formed on the surface-treated surface. An ultraviolet ray was selectively irradiated at the frame-shaped region having the width of 3 mm along the periphery of the surface of each of the bonding films.

Thereafter, the monocrystalline silicon substrate and the glass substrate were heated while pressing them so that the bonding films are bonded to each other. In this way, a bonded body was obtained, in which the monocrystalline silicon substrate was bonded to the glass substrate through the bonding films.

2. Evaluation of Bonded Body

2.1 Evaluation of Bonding Strength (Splitting Strength)

Bonding strength was measured for each of the bonded bodies obtained in the Examples 1 to 17 and the Comparative Examples 1 to 11.

When the first object and the second object were peeled to each other, the bonding strength just before they were peeled was measured. The bonded body just after the first object and the second object were bonded to each other was used for measuring the bonding strength. Furthermore, the bonded body, that a temperature cycle in the range of −40 to 125° C. was repeatedly performed 100 times just after the first object and the second object were bonded to each other, was used for measuring the bonding strength.

The Result of the bonding strength was evaluated according to criteria described below.

Evaluation Criteria for Bonding Strength

A: Bonding strength is 10 MPa (100 kgf/cm²) or more.

B: Bonding strength is 5 MPa (50 kgf/cm²) or more but lower than 10 MPa (100 kgf/cm²).

C: Bonding strength is 1 MPa (10 kgf/cm²) or more but lower than 5 MPa (50 kgf/cm²).

D: Bonding strength is lower than 1 MPa (10 kgf/cm²).

2.2 Evaluation of Dimensional Accuracy

Dimensional accuracy in a thickness direction was measured for each of the bonded bodies obtained in the Examples 1 to 17 and the Comparative Examples 1 to 11.

The evaluation of the dimensional accuracy was performed by measuring a thickness of each corner portion of the bonded body having a squire shape, calculating a difference between a maximum value and a minimum value of the thicknesses measured, and evaluating the difference according to criteria described below.

Evaluation Criteria for Dimensional Accuracy

B: less than 10 μm

D: 10 μm or more

2.3 Evaluation of Chemical Resistance

Each of ten bonded bodies obtained in the Examples 1 to 17 and the Comparative Examples 1 to 11 was immersed in an ink for an ink-jet printer (“HQ4”, produced by Seiko Epson Corporation), which was maintained at a temperature of 80° C., for three weeks. Each of other ten bonded bodies was immersed the ink for 50 days in the same manner as the ten bonded bodies.

Thereafter, the monocrystalline silicon substrate was removed from the glass substrate, and it was checked whether or not the ink penetrated into a bonding interface of the bonded body. The Result of the check was evaluated according to criteria described below.

Evaluation Criteria for Chemical Resistance

A: Ink did not penetrate into the bonded body at all.

B: Ink penetrated into the corner portions of the bonded body slightly.

C: Ink penetrated along the edge portions of the bonded body.

D: Ink penetrated into the inside of the bonded body.

2.4 Evaluation of Infrared Adsorption (FT-IR)

In each of the bonded bodies obtained in the Examples 1 to 17 and the Comparative Examples 1 to 11, the bonding film (plasma polymerization film) of the bonded body was subjected to a infrared adsorption method to obtain an infrared adsorption spectrum having peaks. The following items (1) and (2) were calculated by using the infrared adsorption spectrum.

The item (1) is a relative intensity of a peak derived from Si—H bonds with respect to a peak derived from siloxane (Si—O) bonds. The item (2) is a relative intensity of a peak derived from methyl groups with respect to the peak derived from the siloxane bonds.

2.5 Evaluation of Refractive Index

In each of the bonded bodies obtained in the Examples 1 to 17 and the Comparative Examples 1 to 11, a refractive index of the bonding film (plasma polymerization film) of the bonded body was measured.

2.6 Evaluation of Light Transmission Rate

In each of the bonded bodies obtained in the Examples 1 to 17 and the Comparative Examples 1 to 11, a light transmission rate of the bonded body which can be subjected to a light transmission rate measurement apparatus was measured. The obtained light transmission rate was evaluated according to criteria described below.

Evaluation Criteria for Light Transmission Rate

A: The light transmission rate was 95% or more.

B: The light transmission rate was 90% or more, but lower than 95%.

C: The light transmission rate was 85% or more, but lower than 90%.

D: The light transmission rate was lower than 85%.

Evaluation results of the above items 2.1 to 2.6 are shown in Table 1.

TABLE 1

| | Conditions of manufacturing bonded body | | | | | |
|---|---|---|---|---|---|---|
| | Constituent | | | | Constituent | |
| | material of | | | Output density of | material of | |
| | first base | Bonding film | | high-frequency | second base | Heating |
| | member | Embodiment | Composition | voltage | member | temperature |
| Ex. 1 | Silicon | Plasma | Octamethyltrisiloxane | 25 (100 W) | Glass | 80° C. |
| Ex. 2 | Silicon | polymerization film | | | Glass | 25° C. |
| Ex. 3 | Silicon | | | | Silicon | 80° C. |
| Ex. 4 | Silicon | | | | Stainless steel | 80° C. |
| Ex. 5 | Silicon | | | | Alminum | 80° C. |
| Ex. 6 | Silicon | | | | PET | 80° C. |
| Ex. 7 | Silicon | | | | PI | 80° C. |
| Ex. 8 | Glass | | | | Glass | 80° C. |
| Ex. 9 | Glass | | | | Stainless steel | 80° C. |
| Ex. 10 | Stainless steel | | | | PET | 80° C. |
| Ex. 11 | Stainless steel | | | | PI | 80° C. |
| Ex. 12 | Stainless steel | | | | Alminum | 80° C. |
| Ex. 13 | Silicon | | | 37.5 (150 W) | Glass | 80° C. |
| Ex. 14 | Silicon | | | 50 (200 W) | Glass | 80° C. |
| Ex. 15 | Silicon | | Trimethylgallium | 25 (100 W) | Glass | 80° C. |
| Ex. 16 | Silicon | | | | Silicon | 80° C. |
| Ex. 17 | Silicon | | | | Stainless steel | 80° C. |
| Comp. Ex. 1 | Silicon | Adhesive | Epoxy-based | — | Glass | — |
| Comp. Ex. 2 | Silicon | | adhesive | | Silicon | |
| Comp. Ex. 3 | Silicon | | | | Stainless steel | |
| Comp. Ex. 4 | Silicon | Coating | Polyorganosiloxane- | — | Glass | 80° C. |
| Comp. Ex. 5 | Silicon | film | based coating film | | Stainless steel | 80° C. |
| Comp. Ex. 6 | Silicon | | | | PET | 80° C. |
| Comp. Ex. 7 | Glass | | | | Glass | 80° C. |
| Comp. Ex. 8 | Stainless steel | | | | Glass | 80° C. |
| Comp. Ex. 9 | Stainless steel | | | | Stainless steel | 80° C. |
| Comp. Ex. 10 | Stainless steel | | | | PET | 80° C. |
| Comp. Ex. 11 | Silicon | Vapor- | Polysilazane-based | — | Glass | 80° C. |
| | | deposited | Vapor-deposited | | | |
| | | film | film | | | |

| | Evluation results | | | | | | | | |
|---|---|---|---|---|---|---|---|---|---|
| | Bonding Strength | | | | | | | | |
| | Just after | | | Chemical | | | | | |
| | completion | After | | resistance | | | | | Light |
| | of bonding | Temperature | Dimensional | After 3 | After 50 | Si—H/ | CH₃/ | Refractive | transmission |
| | process | cycle | accuracy | weeks | days | Si—O—Si | Si—O—Si | intex | rate |
| Ex. 1 | B | CB | B | A | BA | 0.02 | 0.22 | 1.44 | — |
| Ex. 2 | B | CB | B | A | BA | 0.02 | 0.22 | 1.44 | — |
| Ex. 3 | B | CB | B | A | BA | 0.02 | 0.22 | 1.44 | — |
| Ex. 4 | B | CB | B | A | BA | 0.02 | 0.22 | 1.44 | — |
| Ex. 5 | B | CB | B | A | BA | 0.02 | 0.22 | 1.44 | — |
| Ex. 6 | A | BA | B | A | CB | 0.02 | 0.22 | 1.44 | — |
| Ex. 7 | A | BA | B | A | CB | 0.02 | 0.22 | 1.44 | — |
| Ex. 8 | B | CB | B | A | BA | 0.02 | 0.22 | 1.44 | A |
| Ex. 9 | B | CB | B | A | BA | 0.02 | 0.22 | 1.44 | — |
| Ex. 10 | A | BA | B | A | CB | 0.02 | 0.22 | 1.44 | — |
| Ex. 11 | A | BA | B | A | CB | 0.02 | 0.22 | 1.44 | — |
| Ex. 12 | B | CB | B | A | BA | 0.02 | 0.22 | 1.44 | — |
| Ex. 13 | B | CB | B | A | BA | 0.02 | 0.20 | 1.45 | — |
| Ex. 14 | B | CB | B | A | CB | 0.03 | 0.17 | 1.49 | — |
| Ex. 15 | B | CB | B | B | CB | — | — | — | — |
| Ex. 16 | B | CB | B | B | CB | — | — | — | — |
| Ex. 17 | B | CB | B | B | CB | — | — | — | — |
| Comp. Ex. 1 | C | D | D | C | D | — | — | — | — |
| Comp. Ex. 2 | C | D | D | C | D | — | — | — | — |
| Comp. Ex. 3 | C | D | D | C | D | — | — | — | — |
| Comp. Ex. 4 | B | D | D | B | C | 0 | 0.49 | 1.56 | — |
| Comp. Ex. 5 | B | D | D | B | C | 0 | 0.49 | 1.56 | — |
| Comp. Ex. 6 | B | D | D | B | D | 0 | 0.49 | 1.56 | — |
| Comp. Ex. 7 | B | D | D | B | C | 0 | 0.49 | 1.56 | D |
| Comp. Ex. 8 | B | D | D | B | C | 0 | 0.49 | 1.56 | — |
| Comp. Ex. 9 | B | D | D | B | C | 0 | 0.49 | 1.56 | — |
| Comp. Ex. 10 | B | D | D | B | D | 0 | 0.49 | 1.56 | — |
| Comp. Ex. 11 | C | D | B | C | D | 0 | — | — | — |

 PET: Polyethyrene terephathalate
PI: Polyimide
In evaluation results, the symbol “BA” represents that the evaluation results of both B and A are mixed.

As is apparent in Table 1, the bonded bodies obtained in the Examples 1 to 17 exhibited excellent characteristics in the bonding strength, the dimensional accuracy and the chemical resistance.

On the other hand, the bonded bodies obtained in the Comparative Examples 1 to 11 exhibited insufficient bonding strength and insufficient chemical resistance. Furthermore, it was found that the bonded bodies obtained in the Comparative Examples 1 to 11 had low dimensional accuracy.

### INDUSTRIAL APPLICABILITY

A bonding method of manufacturing a bonded body is provided. The bonding method comprises: providing a first object in which a plasma polymerization film is formed on a base member, the plasma polymerization film having a surface; applying an energy to the surface of the plasma polymerization film to activate the surface; providing a second object having a surface to be bonded to the surface of the plasma polymerization film of the first object and no plasma polymerization film onto the surface of the second object; and bonding the surface of the second object and the surface of the activated plasma polymerization film to thereby bond the surface of the plasma polymerization film to the surface of the second object to obtain the bonded body.

It is possible to firmly and efficiently bond the second object and the plasma polymerization film provided in the first object together with high dimensional accuracy.

Furthermore, since the second object having no plasma polymerization film is not exposed by plasma, it is possible to use various kinds of constituent materials of the second object without making consideration of durability thereof to the plasma. Accordingly, the bonding method according to the present invention has industrial applicability.

What is claimed is:

1. A bonding method of manufacturing a bonded body, the bonding method comprising:
after providing a first object in which a plasma polymerization film having a surface is formed on a base member, applying an energy to the surface of the plasma polymerization film to activate the surface; and
after providing a second object having a surface to be bonded to the surface of the plasma polymerization film of the first object and no plasma polymerization film onto the surface of the second object, bonding the surface of the second object and the surface of the activated plasma polymerization film so that the surface of the plasma polymerization film is bonded to the surface of the second object to obtain the bonded body.

2. The bonding method as claimed in claim 1, wherein the second object includes bonds, hydroxyl groups bonded to the bonds and active bonding hands formed by cutting the bonds, wherein at least one of the hydroxyl groups and the active bonding hands exists on the surface of the second object,
wherein the surface of the second object is bonded to the surface of the plasma polymerization film.

3. The bonding method as claimed in claim 1, wherein the surface of the second object is covered with an oxide film.

4. The bonding method as claimed in claim 1, wherein the plasma polymerization film is constituted of polyorganosiloxane or an organic metallic polymer as a main component thereof.

5. The bonding method as claimed in claim 4, wherein the polyorganosiloxane is constituted of a polymer of octamethyltrisiloxane as a main component thereof.

6. The bonding method as claimed in claim 4, wherein the polyorganosiloxane includes Si—H bonds in a chemical structure thereof.

7. The bonding method as claimed in claim 6, wherein the plasma polymerization film constituted of the polyorganosiloxane including the Si—H bonds and siloxane bonds is subjected to an infrared adsorption spectroscopy to obtain spectrum having peaks, wherein when an intensity of the peak derived from the siloxane bonds is defined as “1”, an intensity of the peak derived from the Si—H bonds is in the range of 0.001 to 0.2.

8. The bonding method as claimed in claim 4, wherein the plasma polymerization film constituted of the polyorganosiloxane including siloxane bonds and methyl groups is subjected to an infrared adsorption spectroscopy to obtain spectrum having peaks, wherein when an intensity of the peak derived from the siloxane bonds is defined as “1”, an intensity of the peak derived from the methyl groups is in the range of 0.05 to 0.45.

9. The bonding method as claimed in claim 4, wherein the organic metallic polymer is constituted of a polymer of trimethylgallium or trimethylaluminum as a main component thereof.

10. The bonding method as claimed in claim 1, wherein an average thickness of the plasma polymerization film is in the range of 10 to 10000 nm.

11. The bonding method as claimed in claim 1, wherein the energy includes an energy beam, wherein the energy beam is irradiated to the surface of the plasma polymerization film in the applying the energy to the surface of the plasma polymerization film.

12. The bonding method as claimed in claim 11, wherein the energy beam is an ultraviolet light having a wavelength of 150 to 300 nm.

13. The bonding method as claimed in claim 1, wherein the applying the energy to the surface of the plasma polymerization film is performed in an atmosphere.

14. The bonding method as claimed in claim 1 further comprising subjecting the bonded body to a heating treatment after bonding the surface of the second object and the surface of the activated plasma polymerization film.

15. The bonding method as claimed in claim 14, wherein the heating treatment is performed at a temperature in the range of 25 to 100° C.

16. The bonding method as claimed in claim 1 further comprising pressuring the bonded body after bonding the surface of the second object and the surface of the activated plasma polymerization film.

17. The bonding method as claimed in claim 16, wherein the pressuring the bonded body is performed under a pressure in the range of 1 to 10 MPa.

18. The bonding method as claimed in claim 1, wherein the bonding the surface of the second object and the surface of the activated plasma polymerization film is started within 60 minutes after the applying the energy to the surface of the plasma polymerization film.

19. The bonding method as claimed in claim 1, wherein the base member has a surface on which the plasma polymerization film is formed, wherein the providing the first object includes subjecting the surface of the base member to a surface treatment using plasma, and then forming the plasma polymerization film on the surface-treated surface of the base member to obtain the first object.

20. A bonded body comprising:
a first base member;
a plasma polymerization film formed on the first base member, the plasma polymerization film having a surface; and
a second base member formed on the surface of the plasma polymerization film;
wherein the second base member is bonded to the first base member through the plasma polymerization film.

21. A droplet ejection head provided with the bonded body defined in claim 20.

22. A droplet ejection apparatus provided with the droplet ejection head defined in claim 21.
